(19) United States
(12) Patent Application Publication
(10) Pub. No.: US 2026/0038231 A1
(43) Pub. Date: Feb. 5, 2026

(54) ELECTRONIC APPARATUS, METHOD PERFORMED BY THE SAME AND COMPUTER-READABLE STORAGE MEDIUM

(71) Applicant: SAMSUNG ELECTRONICS CO., LTD., Suwon-si (KR)

(72) Inventors: Jia LI, Beijing (CN); Fan WANG, Beijing (CN); Hyunhee PARK, Suwon-si (KR); Zikun LIU, Beijing (CN); Juan LEI, Beijing (CN); Hyungju CHUN, Suwon-si (KR)

(73) Assignee: SAMSUNG ELECTRONICS CO., LTD., Suwon-si (KR)

(21) Appl. No.: 19/079,019

(22) Filed: Mar. 13, 2025

Related U.S. Application Data
(63) Continuation of application No. PCT/KR2025/001217, filed on Jan. 22, 2025.

(30) Foreign Application Priority Data
Jul. 31, 2024 (CN) 202411045510.0

(51) Int. Cl. G06V 10/44; G06T 5/20; G06T 7/50; G06T 7/70; G06T 9/00; G06V 10/80

(52) U.S. Cl. CPC G06V 10/44; G06T 5/20; G06T 7/50; G06T 7/70; G06T 9/00; G06V 10/806

(57) ABSTRACT

A method performed by an electronic apparatus, includes: obtaining position information of an object in an input image; predicting trailing blur state information of the input image, based on the position information and the input image; and obtaining an output image by performing processing on the input image, based on the predicted trailing blur state information.

### CROSS-REFERENCE TO RELATED APPLICATIONS

This application is a by-pass continuation application of International Application No. PCT/KR2025/001217, filed on Jan. 22, 2025, which is based on and claims priority to Chinese Patent Application No. 202411045510.0, filed on Jul. 31, 2024, in the China National Intellectual Property Administration, the disclosures of which are incorporated by reference herein their entireties.

### TECHNICAL FIELD

The disclosure relates to a field of image processing and a field of artificial intelligence, and specifically, to a method performed by an electronic apparatus, the electronic apparatus, and a computer-readable storage medium.

### BACKGROUND

With the rapid development of various smart apparatuses (e.g., smartphones, cameras, etc.), users have higher requirement for image quality. A ‘Coma’ is an optical system imaging error caused by design defects in lens or other components, where light rays deviating from an optical axis fail to converge into a point on an ideal imaging plane, forming a comet-like spot with a trailing tail.

In an actual capturing process, due to lens hardware and optical imaging and other reasons, the image quality will be degraded from a center to an edge, the quality of four-corner areas farthest from the center of the image is worst, it will show directional trailing blur, i.e., a Coma phenomenon. With the gradual increase in the user requirement for the quality of the shot image, the consistency requirement for the global quality of the shot image is also gradually increasing, for example, when capturing group portraits, people in the corners should be clear; when capturing menus, the text on the edges should be clear.

However, the global quality of the current imaging image is often inconsistent, the imaging blur occurs at four edge corners, which affects the user experience and image understanding and cannot meet the user's needs.

The global quality of the current imaging image is often inconsistent, the imaging blur occurs at four edge corners, which affects the user experience and image understanding and cannot meet the user's needs. Four-corner blur is an imaging deviation that occurs in the four-corner edge areas of the image under the combined influence of the inherent properties of the optical imaging hardware and the relative position of the captured object, so that the quality of the captured image gradually decreases from the center area to the periphery. Typical performance is that there are trailing artifacts with specific directions in the four-corner areas, as shown in FIG. 1.

In order to solve this problem, the four-corner blur may be removed by improving the quality of the hardware, e.g., by designing and adjusting the lens combination to improve the quality of the edge area of the image. However, although this hardware improvement method may solve the four-corner trailing blur problem to a certain extent, this method has a high hardware cost and leads to more serious other imaging quality problems, e.g., it may change the shape of the subject. In addition, the current way of removing the four-corner blur by software algorithms only uses ordinary image deblurring techniques without considering the characteristics of the four-corner trailing blur itself, however, the four-corner trailing blur is not different from other blurs, and therefore, the ordinary image deblurring techniques cannot completely solve the trailing blur problem.

### SUMMARY

According to an aspect of the disclosure, a method performed by an electronic apparatus, includes: obtaining position information of an object in an input image; predicting trailing blur state information of the input image, based on the position information and the input image; and obtaining an output image by performing processing on the input image, based on the predicted trailing blur state information.

According to an aspect of the disclosure, an electronic apparatus includes: a memory; and a processor coupled to the memory and configured to: obtain position information of an object in an input image; predict trailing blur state information of the input image, based on the position information and the input image; and obtain an output image by performing processing on the input image, based on the predicted trailing blur state information.

According to an aspect of the disclosure, a computer-readable storage medium storing instructions that, when executed by at least one processor, cause the at least one processor to: obtain position information of an object in an input image; predict trailing blur state information of the input image, based on the position information and the input image; and obtain an output image by performing processing on the input image, based on the predicted trailing blur state information.

The above general description and the detailed descriptions that follow are merely exemplary and explanatory and do not limit the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates trailing blur formation;

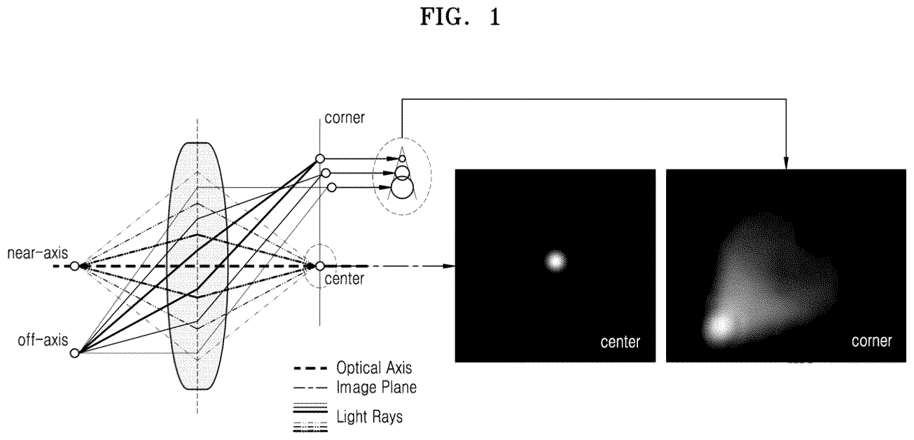

FIG. 2 illustrates a method performed by an electronic apparatus according to embodiments of the disclosure;

FIG. 3 illustrates an operation of obtaining position information of an object in an input image in a camera coordinate system, according to embodiments of the disclosure;

FIG. 4 illustrates operations of a Coma prediction module according to embodiments of the disclosure;

FIG. 5 illustrates operations of a two-level attention module included in a Coma prediction module according to embodiments of the disclosure;

FIG. 6 illustrates operations of a Coma attention module included in a Coma prediction module according to embodiments of the disclosure;

FIG. 7 illustrates operations of an up-sampling module included in a Coma prediction module according to embodiments of the disclosure;

FIG. 8 illustrates an example architecture of a method according to embodiments of the disclosure;

FIG. 9 illustrates an example of a method according to embodiments of the disclosure;

FIG. 10 illustrates a first convolution operation according to embodiments of the disclosure;

FIG. 11 illustrates detailed operations of a first convolution operation according to embodiments of the disclosure;

FIG. 12 illustrates an example of convolution kernel value adjustment according to embodiments of the disclosure;

FIG. 13 illustrates an example of convolution direction estimation according to embodiments of the disclosure;

FIG. 14 illustrates an example of convolution direction fine-tuning according to embodiments of the disclosure;

FIG. 15A illustrates a comparison of employing a first convolution operation according to embodiments of the disclosure with employing a conventional deformable convolution, according to embodiments of the disclosure;

FIG. 15B illustrates a comparison of employing a first convolution operation according to embodiments of the disclosure with employing a conventional deformable convolution, according to embodiments of the disclosure;

FIG. 16 illustrates a method including a simulate aperture adjustment operation according to embodiments of the disclosure;

FIG. 17 illustrates aperture mapping according to embodiments of the disclosure;

FIG. 18 illustrates a block diagram of establishing an aperture mapping pool according to embodiments of the disclosure;

FIG. 19 illustrates a detailed process of establishing an aperture mapping pool according to embodiments of the disclosure;

FIG. 20 illustrates a schematic diagram showing a simulate aperture adjustment operation according to embodiments of the disclosure;

FIG. 21 illustrates a detailed process of a simulate aperture adjustment operation according to embodiments of the disclosure;

FIG. 22 illustrates a schematic diagram where a method according to embodiments of the disclosure is applied to a camera capturing scenario or a photo album image editing scenario;

FIG. 23 illustrates an example where a method according to embodiments of the disclosure is applied to a camera capturing scenario;

FIG. 24 illustrates an example where a method according to embodiments of the disclosure is applied to a camera capturing scenario;

FIG. 25 illustrates an example where a method according to embodiments of the disclosure is applied to a photo album image editing scenario;

FIG. 26 illustrates an example where a method according to embodiments of the disclosure is applied to a video recording scenario;

FIG. 27 illustrates an example where a method according to embodiments of the disclosure is applied to a video recording scenario;

FIG. 28 illustrates an electronic apparatus according to embodiments of the disclosure; and

FIG. 29 illustrates a schematic diagram of a structure of an electronic apparatus according to an embodiment of the disclosure.

### DETAILED DESCRIPTION

The following description with reference to the accompanying drawings is provided to aid in a thorough understanding of various embodiments of the disclosure as defined by claims and equivalents thereof. This description includes various specific details to aid in understanding but should only be considered exemplary. Accordingly, those ordinary skills in the art will recognize that various changes and modifications can be made to the various embodiments described herein without departing from the scope and spirit of the disclosure. In addition, descriptions of well-known features and structures may be omitted for the sake of clarity and brevity.

The terms and phrases used in the claims and the following description are not limited to dictionary meaning thereof, but are used only by the inventor to enable a clear and consistent understanding of the disclosure. Accordingly, it should be apparent to those skilled in the art that, the following description of the various embodiments of the disclosure is provided for an illustrative purpose only and is not intended to a purpose of limiting the disclosure as defined by the appended claims and equivalents thereof.

Some terms, “a”, “an” and “the” in a singular form, may also include a plural reference, unless the context clearly indicates otherwise. Thus, for example, a reference to a “part surface” includes a reference to one or more such surfaces. When it refers to one element as being “connected” or “coupled” to another element, the one element may be directly connected or coupled to the other element, or it may refer to a connection relationship between the one element and the other element established through an intermediate element. In addition, “connected” or “coupled” as used herein may include wirelessly connected or wirelessly coupled.

The term “include” or “may include” refers to the presence of a function, operation, or component of the corresponding disclosure that may be used in the various embodiments of the disclosure, and does not limit the presence of one or more additional functions, operations, or features. In addition, the terms “include” or “have” may be interpreted to denote certain features, figures, steps, operations, constituent elements, components, or combinations thereof, but should not be interpreted to exclude the possibility of the presence of one or more other features, figures, steps, operations, constituent elements, components, or combinations thereof.

The term “or” as used in the various embodiments of the disclosure includes any of the listed terms and all combinations thereof. For example, “A or B” may include A, may include B, or may include both A and B. When describing a plurality of (two or more) items, the plurality of items may refer to one, more, or all of the plurality of items if a relationship among the plurality of items is not explicitly defined. For example, for the description “a parameter A comprises A1, A2, A3”, it may be implemented as parameter A comprising A1, A2 or A3, or as parameter A comprising at least two of the three items of the parameter A1, A2, A3. The term “or” is an inclusive term meaning “and/or”.

The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

All terms (including technical or scientific terms) used in the disclosure have the same meaning as understood by those skilled in the art to which the disclosure belongs, unless defined differently. Common terms as defined in dictionaries are interpreted to have a meaning consistent with the context in the relevant technology art and should not be interpreted in an idealized or overly formalistic manner, unless expressly so defined in the disclosure.

At least part of the functions in a device or electronic apparatus provided in the embodiments of the disclosure may be implemented through an AI model, such as, at least one of a plurality of modules of the device or electronic apparatus may be implemented through the AI model. A function associated with AI may be performed through the non-volatile memory, the volatile memory, and the processor.

The processor may include one or more processors. At this time, the one or more processors may be a general purpose processor, such as a central processing unit (CPU), an application processor (AP), or the like, or may be a graphics-only processing unit such as a graphics processing unit (GPU), a visual processing unit (VPU), and/or an AI-dedicated processor such as a neural processing unit (NPU).

The one or more processors control processing of input data in accordance with a predefined operating rule or artificial intelligence (AI) model stored in the non-volatile memory and the volatile memory. The predefined operating rule or artificial intelligence model is provided through training or learning.

The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Here, being provided through learning means that, by applying a learning algorithm to a plurality of learning data, a predefined operating rule or an AI model of a desired characteristic is made. The learning may be performed in a device or electronic apparatus itself in which AI according to embodiments is performed, and/or may be implemented through a separate server/system.

The AI model may include a plurality of neural network layers. Each layer has a plurality of weight values, and performs a neural network calculation by calculating between the input data of this layer (such as, a calculation result of the previous layer and/or the input data of the AI model) and the plurality of weight values of the current layer. Examples of neural networks include, but are not limited to, a convolutional neural network (CNN), a deep neural network (DNN), a recurrent neural network (RNN), a restricted Boltzmann Machine (RBM), a deep belief network (DBN), a bidirectional recurrent deep neural network (BRDNN), a generative adversarial networks (GAN), and a deep Q-network.

The learning algorithm is a method for training a predetermined target device (for example, a robot) using a plurality of learning data to cause, allow, or control the target device to make a determination or prediction. Examples of the learning algorithm include, but are not limited to, supervised learning, unsupervised learning, semi-supervised learning, or reinforcement learning.

The methods of the disclosure may involve one or more of technical fields such as speech, language, image, video, or data intelligence. In an embodiment, when involving the field of speech or language, in the method according to the disclosure executed by electronic apparatus, a speech signal, which is an analog signal, may be received via speech input devices (e.g., a microphone), and the speech part is converted into computer readable text using an automatic speech recognition (ASR) model. The user's intent of utterance may be obtained by interpreting the converted text using a natural language understanding (NLU) model. The ASR model or NLU model may be an artificial intelligence model. The artificial intelligence model may be processed by an artificial intelligence-dedicated processor designed in a hardware structure specified for artificial intelligence model processing. Language understanding is a technique for recognizing and applying/processing human language/text and includes, e.g., natural language processing, machine translation, dialog system, question answering, or speech recognition/synthesis.

In an embodiment, when involving the field of image or video, in the method according to the disclosure executed by electronic apparatus, output data may be obtained by using image data as input data for an artificial intelligence model. The method of the disclosure may involve the field of visual understanding in the artificial intelligence technology, and the visual understanding is a technique for recognizing and processing things as does human vision and includes, e.g., object recognition, object tracking, image retrieval, human recognition, scene recognition, three-dimensional (3D) reconstruction/localization, or image enhancement.

In an embodiment, when involving the field of data intelligence processing, in the method according to the disclosure executed by electronic apparatus, in the reasoning or predicting stage, an artificial intelligence model can be used to perform predictions by using real-time input data. Processors of the electronic apparatus may perform a pre-processing operation on the data to convert into a form appropriate for use as an input for the artificial intelligence model. Reasoning and prediction is a technique of logically reasoning and predicting by determining information and includes, e.g., knowledge-based reasoning, optimization prediction, preference-based planning, or recommendation.

In the disclosure, the artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

Below, the technical solutions of the embodiments of the disclosure and the technical effects produced by the technical solutions of the disclosure will be explained by describing several optional embodiments. It should be noted that, the following embodiments may be referred to, imitated or combined with each other, and the same term, similar features and similar implementation operations in different embodiments will not be described repeatedly.

In order to solve the problems described in the description of related art, the disclosure proposes a method for effectively improving four-corner trailing blur in an input image by considering the characteristics of the four-corner trailing blur without any hardware changes.

Four-corner trailing blur (hereinafter also referred to as “trailing blur”) is different from general blur and the trailing blur state is related to the position of the captured object. The trailing blur may include the coma aberration that a point source of the object appears distorted into a comet-like shape with trailing tail. Therefore, the disclosure proposes to predict trailing blur state information using the position information of the object in the input image, and then guide processing of the input image based on the trailing blur state information, thereby realizing the removal of the trailing blur.

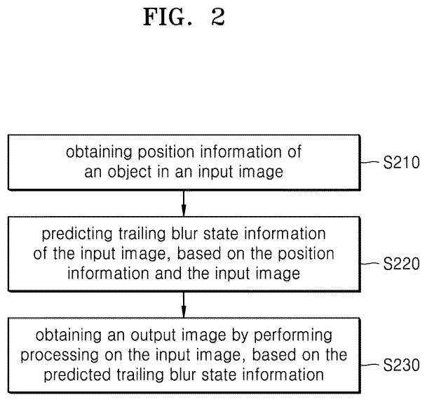

FIG. 2 illustrates a method performed by an electronic apparatus according to embodiments of the disclosure. Referring to FIG. 2, at operation S210, position information of an object in an input image is obtained. According to embodiments, the position information of the object in the input image in a camera coordinate system may be obtained based on camera parameters and a depth map corresponding to the input image, but the way of obtaining the position information is not limited to this. The disclosure does not limit how to obtain the camera parameters and the depth map corresponding to the input image.

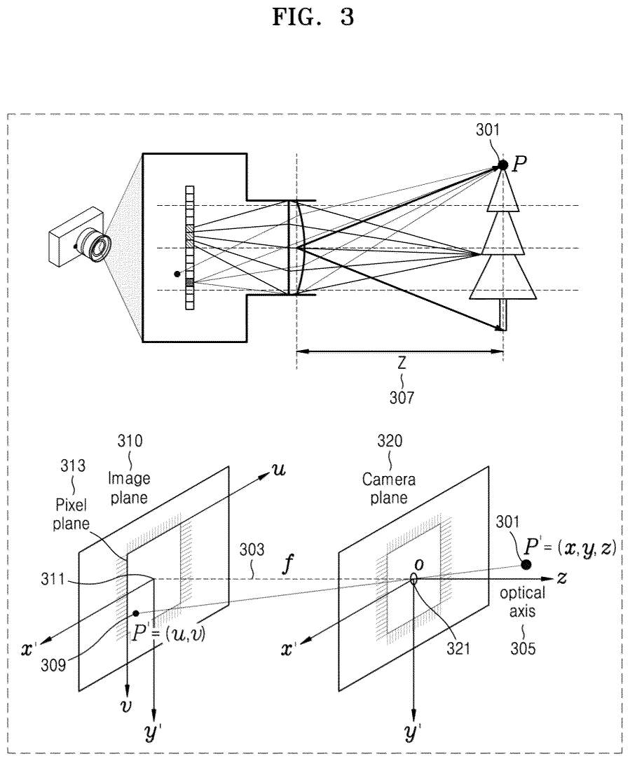

FIG. 3 illustrates an operation of obtaining position information of an object in an input image in a camera coordinate system according to embodiments of the disclosure. As shown in FIG. 3, P 301 is a point of an object (e.g., a tree), and a position of P 301 in the camera coordinate system is defined as P=(x, y, z), which may be finally solved for by transforming from a pixel coordinate system to an image coordinate system, and then, to the camera coordinate system.

In FIG. 3, a coordinate origin 311 of the pixel coordinate system is an upper left vertex of a pixel plane 313, a coordinate origin O′ 311 of the image coordinate system is a center of an image plane 310, a coordinate origin O 321 of the camera coordinate system is an optical center of the camera plane 320, a focal length f 303 is a distance between a projection center (the coordinate origin O 321 of the camera coordinate system) and the image plane 310, an optical axis is perpendicular to the image plane 310 and passes through the projection center, the coordinate origin O′ 311 of the image coordinate system is defined as an intersection point between the optical axis 305 and the image plane 310. According to embodiments, for example, z 307 in the camera coordinate system may be obtained by a depth map corresponding to the input image. It is assumed that a projection point of P in the pixel coordinate system is P′(u, v) 309, a position (x′, y′) of P in the image coordinate system may be solved by the following equation:

$$\{ \begin{matrix}u = \frac{1}{{s}_{u}} {x}^{′} + {c}_{x} \\ v = \frac{1}{{s}_{v}} {y}^{′} + {c}_{y}\end{matrix} \{ \begin{matrix}{x}^{′} = {f}_{1} \frac{x}{z} \\ {y}^{′} = {f}_{2} \frac{x}{y}\end{matrix}$$

Moreover, the position P=(x, y, z) of P in the camera coordinate system may subsequently be solved by the following equation:

$${f}_{x} = \frac{{f}_{1}}{{s}_{u}} , {f}_{y} = \frac{{f}_{2}}{{s}_{v}} ; ( \begin{matrix}u \\ v \\ 1\end{matrix} ) = \frac{1}{z} ( \begin{matrix}{f}_{x} & 0 & {c}_{x} \\ 0 & {f}_{y} & {c}_{y} \\ 0 & 0 & 1\end{matrix} ) ( \begin{matrix}x \\ y \\ z\end{matrix} )$$

where c, and cy are displacements of an origin, sᵤ and sᵥ are a pixel width and a pixel height, and f₁ and f₂ are offsets of a focal length on the image coordinate system. In the above equation,

$$( \begin{matrix}{f}_{x} & 0 & {c}_{x} \\ 0 & {f}_{y} & {c}_{y} \\ 0 & 0 & 1\end{matrix} )$$

may be determined based on the camera parameters, and in a case where the camera parameters are known, a relationship between the position of P in the camera coordinate system and the position of P in the pixel coordinate system may be obtained, and the position of the object in the camera coordinate system may be calculated based on the relationship. The position information of the object in the camera coordinate system is important for predicting trailing blur state information.

At operation S220, trailing blur state information of the input image is predicted based on the position information and the input image. Since information on a trailing degree of an image is related to an input image itself and is related to position information of an object in an input image, in the embodiment according to the disclosure, the trailing blur state information of the input image is predicted based on the position information and the input image, and thus, more accurate trailing blur state information may be predicted.

Hereinafter, the operation for predicting the trailing blur state information of the input image is also referred to as “Coma prediction” or “Coma estimation”, which may be performed by a Coma prediction module according to embodiments of the disclosure.

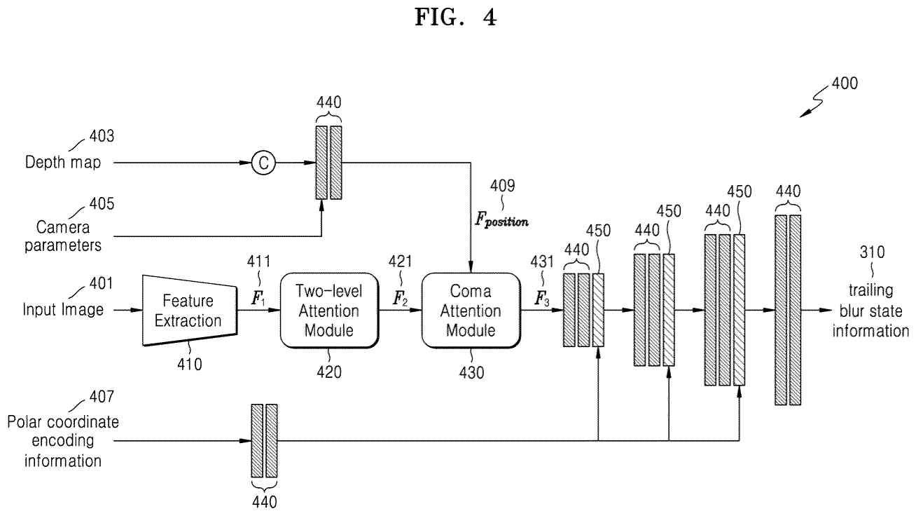

FIG. 4 illustrates operations of a Coma prediction module 400 according to embodiments of the disclosure. The above operations performed by the Coma prediction module 400 are now described with reference to FIG. 4.

For example, operation S220 may include: first, performing feature extraction on the input image to obtain an image feature of the input image; second, obtaining a trailing blur feature of the input image based on the image feature; and finally, obtaining the trailing blur state information based on the position information and the trailing blur feature.

According to embodiments, the trailing blur state information may include at least one of direction information, degree information, and probability information of trailing blur in at least one area, but is not limited thereto.

The direction of the trailing blur state may be related to a distance from the optical axis. For example, the direction of the trailing blur state may be related to whether the point of light extends away from the optical axis or towards the optical axis. The degree of the trailing blur state may be related to the shape and curvature radius of the lens, field-of-view (FOV), and the position of the captured object. The probability information of trailing blur may be related to textures or colors of the input image.

As shown in FIG. 4, a position Fₚₒₛᵢₜᵢₒₙ 409 of an object in an input image 401 in the camera coordinate system may be calculated based on a depth map 403 of the input image 401 and camera parameters 405. An image feature F₁ 411 of the input image 401 is obtained through feature extraction 410 on the input image 401, for example, a feature extraction model composed of multi-layer convolution may be utilized to perform the feature extraction 410 on the input image 401 to obtain the image feature F₁ 411 of the input image 401. Subsequently, the image feature F₁ 411 passes through a two-level attention module 420 to obtain a trailing blur feature, which is denoted as F₂ 421 in FIG. 4.

According to embodiments, the obtaining of the trailing blur feature based on the image feature may include: dividing the image feature into an image feature corresponding to an edge area of the input image and an image feature corresponding to a center area of the input image; dividing the image feature corresponding to the edge area into patches of a first size and dividing the image feature corresponding to the center area into patches of a second size, wherein the first size is smaller than the second size; performing a self-attention operation on the patches of the first size and the patches of the second size respectively to obtain a first feature and a second feature; performing a cross-attention operation on the first feature and the second feature to obtain a third feature; and obtaining the trailing blur feature based on the third feature.

For example, the operation of obtaining the trailing blur feature may be performed by the two-level attention module 420 illustrated in FIG. 4.

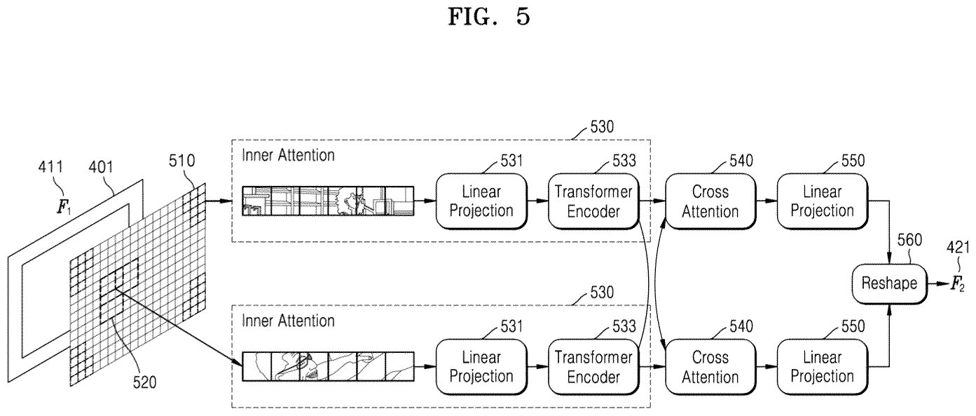

FIG. 5 illustrates a schematic diagram of operations of a two-level attention module 420 included in a Coma prediction module 400 according to embodiments of the disclosure. As shown in FIG. 5, an image feature F₁ 411 of an input image 401 is divided into an image feature corresponding to an edge area 510 of the input image and an image feature corresponding to a center area 520 of the input image, and the image feature corresponding to the edge area 510 is divided into patches of a first size s1, and the image feature corresponding to the center area 520 is divided into patches of a second size s2, wherein s1<s2 (e.g., two levels of division are performed). Because the edge area 510 is more prone to four-corner blur compared to the center area 520, the edge area 510 may be divided into the patches of the smaller size. Inner attention 530 computations are performed on the two different sizes of patches respectively, e.g., linear mapping (e.g., linear projection 531) is performed on the two different sizes of patches respectively, and feature encoding is performed on the result of the linear mapping using a Transformer encoder 533. The inner attention 530 may strengthen the internal interaction from neighborhood patches of the same level (e.g., same area). For example, the inner attention 530 may strengthen the internal interaction from neighborhood patches of the edge area. The inner attention 530 may strengthen the internal interaction from neighborhood patches of the center area. The inner attention 530 may include the linear projection 531, transformer encoder 533 and convolution operations. The transformer encoder 533 may perform a self-attention computation. Self-attention is an attention mechanism relating different positions of a single sequence in order to compute a representation of the sequence. Self-attention operation on the patches may compute the correlation between the neighborhood patches. The feature obtained by performing the self-attention operation on the patches of the first size s1 is a first feature, and the feature obtained by performing the self-attention operation on the patches of the second size s2 is a second feature. Since patches at the same level have similar degree of trailing blur in different directions, correlation between patches may be recognized by the inner attention 530 operation.

Subsequently, as shown in FIG. 5, cross attention 540 computations are performed on two levels of features (e.g., the first feature and the second feature) to ensure feature interaction between the different levels of patches. Usually, neighboring patches have trailing blur with similar direction but different intensity. In order to enhance the correlation between the two levels of patches, cross attention 540 may be used to facilitate information flow between the different patches. Cross attention 540 is an attention mechanism for feature fusion. Cross attention 540 may operate an attention mechanism between different sequences to compute interactions across the different sequences. Cross attention 540 may compute the correlation between the different level (e.g., area) For example, cross attention 540 may compute the correlation between the patches of the center area and the patches of the edge area.

Finally, linear mapping (e.g., linear projection 550) is performed on a third feature obtained through the cross-attention 540 operation, and a shape of the feature after the linear mapping (e.g., linear projection 550) is restored to be consistent with the size of the image feature F₁ 411 of the input image to obtain a feature F₂ 421, which indicates the trailing blur feature. According to embodiments of the disclosure, different processing strategies are applied to the edge area 510 with severe blur and the center area 520 with slight blur by means of the two-level attention module. Specifically, for the edge area level, since the area at this level has a high degree of blur and a blur probability, a small-size and high-density patch is used to compute its inner correlation, whereas for the center area level, since the area at this level has a small degree of blur and a low blur probability, a large-size and low-density patch is used, which may be advantageous to improve the computation efficiency.

Returning to refer to FIG. 4, as shown in FIG. 4, after obtaining the trailing blur feature F₂ 421, trailing blur state information 310 may be obtained based on position information Fₚₒₛᵢₜᵢₒₙ 409 and the trailing blur feature F₂ 421. For example, a self-attention operation may be performed on the position information 409 and the trailing blur feature to obtain a fourth feature, and then, the trailing blur state information 310 may be obtained based on the fourth feature. The above operations may be performed by a Coma attention module 430 shown in FIG. 4.

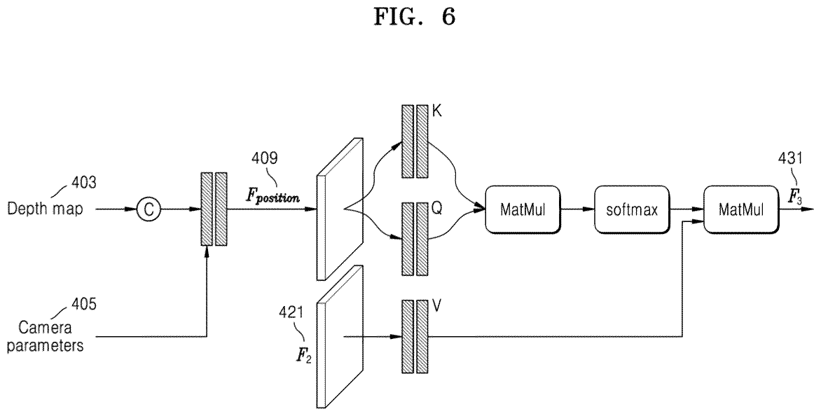

FIG. 6 illustrates operations of a Coma attention module 430 included in a Coma prediction module 400 according to embodiments of the disclosure. As shown in FIG. 6, the input to the module includes a depth map 403, camera parameters 405, and the trailing blur feature F₂ 421 output from the two-level attention module. The depth map 403 and the camera parameters 405 are passed through a convolution module to obtain the position information Fₚₒₛᵢₜᵢₒₙ 409, and subsequently, Fₚₒₛᵢₜᵢₒₙ 409 together with F₂ 421 are subjected to a self-attention computation to obtain the fourth feature F₃ 431, wherein a self-attention computation for K, Q, V is as shown in the following equation:

$${F}_{3} = Softmax ( \frac{Q {K}^{T}}{\sqrt{d}} ) V$$

where d is a normalization parameter and Softmax(*) is an activation function.

Referring back to FIG. 4, after obtaining the fourth feature F₃ 431, the trailing blur state information 310 may be obtained based on the fourth feature F₃ 431. According to embodiments, the obtaining of the trailing blur state information 310 based on the fourth feature 431 may include: obtaining polar coordinate encoding information 407 corresponding to the input image 401; and performing up-sampling of the fourth feature 431 based on the polar coordinate encoding information 407 to obtain the trailing blur state information 310. The above operation may be performed by an up-sampling module according to embodiments of the disclosure.

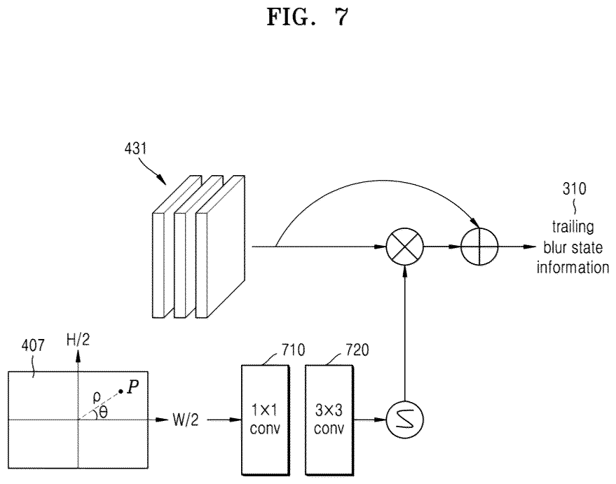

FIG. 7 illustrates operations of an up-sampling module included in a Coma prediction module 400 according to embodiments of the disclosure. As shown in FIG. 4, the input to the up-sampling module may include polar coordinate encoding information 407 and the fourth feature F₃ 431 output by the Coma attention module 430. For example, the polar coordinate encoding information 407 may be obtained by converting the pixel coordinate encoding information of the input image 401 by utilizing a transformation relationship between a pixel coordinate system and a polar coordinate system. The up-sampling module may include a common convolution computation and a position attention computation, with the common convolution computation being shown in a 440 in FIG. 4 and the position attention computation being shown in a 450 in FIG. 4.

For any point P in the plane (width and height are W and H, respectively), its polar coordinates include a distance p from a center of the plane and a deflection angle θ, where the farther away the distance p is, the greater the degree of the trailing blur is, while the deflection direction of the position is related to the direction of the trailing blur, so that the position relationship of the trailing blur may be further enhanced by further combining the polar coordinate encoding information of the input image in the up-sampling prediction (that is, using the position attention based on the polar coordinate encoding information to guide the up-sampling prediction), thereby obtaining more accurate trailing blur state information.

For example, as shown in FIG. 7, 1*1 convolution 710 and 3*3 convolution 720 may be performed sequentially on the polar coordinate encoding information 407, and the result of the convolutions, after passing through an activation function may be multiplied with the result of performing the common convolution computation on the fourth feature F₃ 431, and the multiplication result may be added with F₃ 431 to obtain the final trailing blur state information 310. Relevant details of predicting the trailing blur state information 310 according to embodiments of the disclosure have been described above in connection with FIGS. 4 to 7.

Returning back to FIG. 2, after predicting the trailing blur state information of the input image, at operation S230, processing may be performed on the input image 401 based on the predicted trailing blur state information 310 to obtain an output image. According to embodiments, since the trailing blur is related to the position information of the object in the input image 401, more accurate trailing blur state information 310 may be predicted based on the position information of the object in the input image and the input image 401, and performing the processing on the input image 401 under the guidance of the more accurate trailing blur state information 310 effectively improves the trailing blur in the input image 401, so that it is possible to improve the trailing blur in the input image 401 by considering the characteristics of the four-corner trailing blur without any hardware change, to obtain a higher quality output image.

In the following paragraphs, operation S230 will be further described in detail in connection with the accompanying drawings.

According to embodiments, operation S230 may include: sequentially performing a feature encoding operation, a simulate aperture adjustment operation, and a feature decoding operation on the input image 401 based on the trailing blur state information 310 to obtain the output image. That is, the feature encoding operation, the simulate aperture adjustment operation (which may also be referred to as “aperture simulate adaptation”), and the feature decoding operation may be performed under the guidance of the trailing blur state information 310.

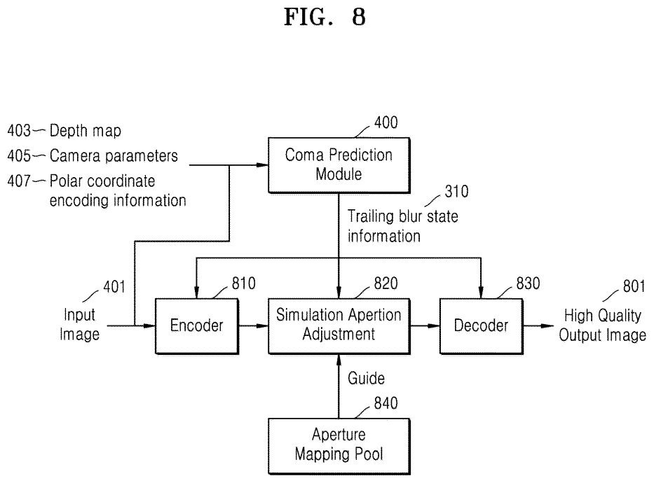

FIG. 8 illustrates a method according to embodiments of the disclosure. As shown in FIG. 8, for example, as described above, the Coma prediction module 400 according to embodiments of the disclosure may obtain position information of an object in an input image 401 in a camera coordinate system based on a depth map 403 corresponding to the input image 401 and camera parameters 405, and predict trailing blur state information 310 based on the position information and the input image 401.

In an embodiment, the trailing blur state information 310 may be further predicted by combining the polar coordinate encoding information 407 of the input image 401. After the trailing blur state information 310 is predicted, at least one of an encoding operation, a simulate aperture adjustment operation, and a feature decoding operation may be directed based on the trailing blur state information 310. For example, as shown in FIG. 8, the trailing blur state information 310 may be utilized to guide the encoding operation of an encoder 810, the aperture simulate adjustment 820 operation, and the decoding operation of a decoder 830, thereby obtaining a high-quality output image 801.

According to embodiments, the sequentially performing of the feature encoding operation, the simulate aperture adjustment operation, and the feature decoding operation on the input image based on the trailing blur state information 310 to obtain the output image may include: performing the feature encoding operation on the input image based on the trailing blur state information 310 to obtain an encoded feature; performing the simulate aperture adjustment operation on the encoded feature based on the trailing blur state information 310 and a preset aperture mapping pool 840 to obtain an aperture-adjusted feature; and performing the feature decoding operation on the aperture-adjusted feature based on the trailing blur state information 310 to obtain the output image.

According to embodiments, at least one of the encoding operation of the encoder 810 may be guided based on the trailing blur state information 310, at least one of the simulate aperture adjustment 820 operation may be guided based on the trailing blur state information 310, and at least one of the feature decoding operation of the decoder 830 may be guided based on the trailing blur state information 310.

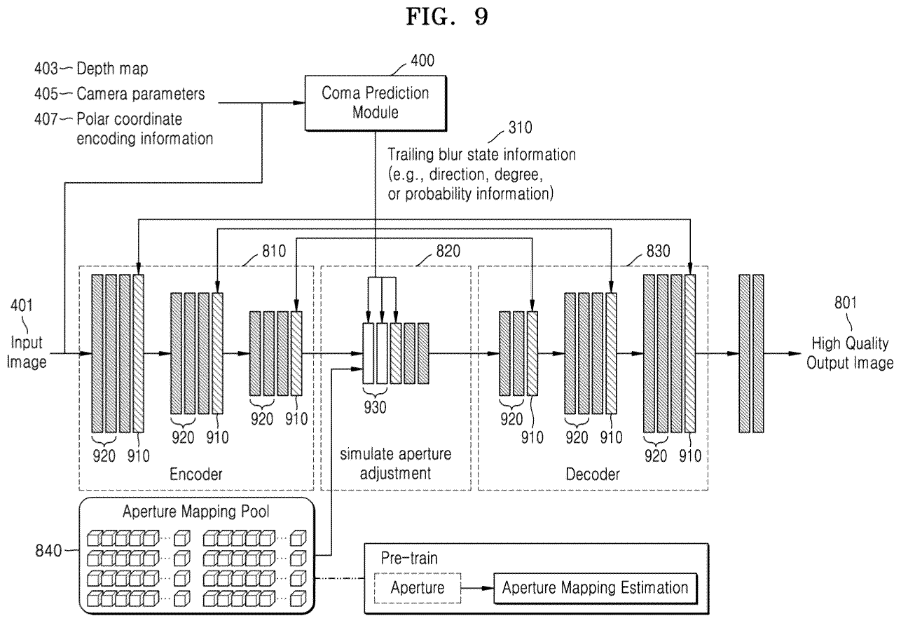

FIG. 9 illustrates an example of a method according to embodiments of the disclosure. For example, as shown in FIG. 9, at least one of the feature encoding operation of the encoder 810, the simulate aperture adjustment 820 operation, and the feature decoding operation of the decoder 830 may include a first convolution 910 operation (the operation indicated by 910 in FIG. 9), wherein the sequentially performing of the feature encoding operation of the encoder 810, the simulate aperture adjustment 820 operation, and the feature decoding operation of the decoder 830 on the input image 401 based on the trailing blur state information 310 to obtain the output image includes: adjusting a convolution kernel used in the first convolution 910 operation based on the trailing blur state information 310. The first convolution 910 operation may also be referred to as a “dynamic convolution operation”. Since different areas of the input image have different trailing blur states, e.g., the degrees and directions of the trailing blur are different in different areas, a conventional fixed-size convolution kernel is not suitable for removing the trailing blur, and if the input image is processed according to the conventional fixed-size convolution kernel, it may result that the trailing blur-free areas are also changed while the trailing blur is removed. Therefore, the disclosure further proposes a first convolution 910 operation based on light attention. In the first convolution 910 operation based on light attention, the convolution kernel is adjusted based on the trailing blur state information, e.g., a shape and a value of the convolution kernel are adjusted, so as to realize dynamic adaptive convolution based on the characteristics of the trailing blur in different areas, which ensures that the trailing blur-free areas are not changed while the trailing blur is removed.

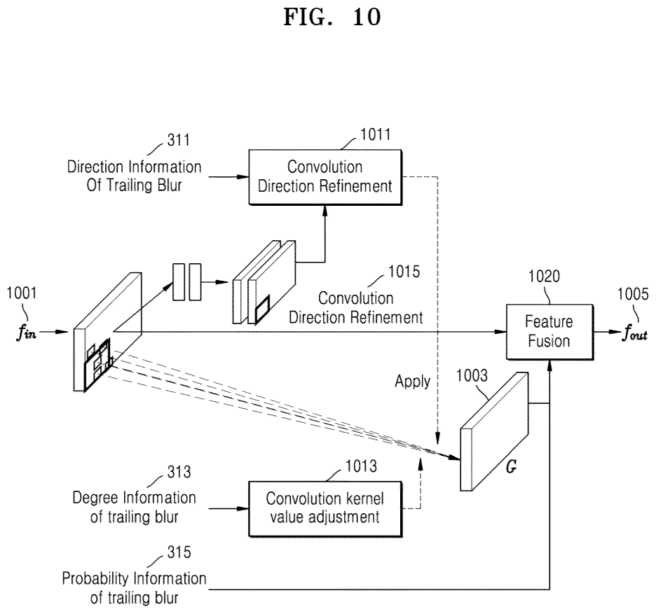

FIG. 10 illustrates a first convolution 910 operation according to embodiments of the disclosure. The first convolution 910 operation according to embodiments of the disclosure is described below with reference to FIG. 10. According to embodiments, the trailing blur state information 310 may include direction information 311 (which may be represented by L[direction]), degree information 313 (which may be represented by L[degree]) and probability information 315 (which may be represented by L[weight]) of trailing blur in at least one area. In this case, for example, the first convolution 910 operation according to embodiments of the disclosure may include: adjusting 1013 a value of a convolution kernel based on the degree information 313 of the trailing blur, and adjusting a shape of the convolution kernel based on the direction information 311 of the trailing blur; performing, by using the adjusted convolution kernel, a convolution operation on a feature on which the first convolution operation is to be performed, to obtain the first convolution feature; and fusing 1020 the feature on which the first convolution 910 operation is to be performed and the first convolution feature based on the probability information 315 of the trailing blur to obtain an output feature of the first convolution operation.

For example, as shown in FIG. 10, a value of a convolution kernel may be adjusted based on the degree information 313 of the trailing blur (e.g., “convolution kernel value adjustment” is performed).

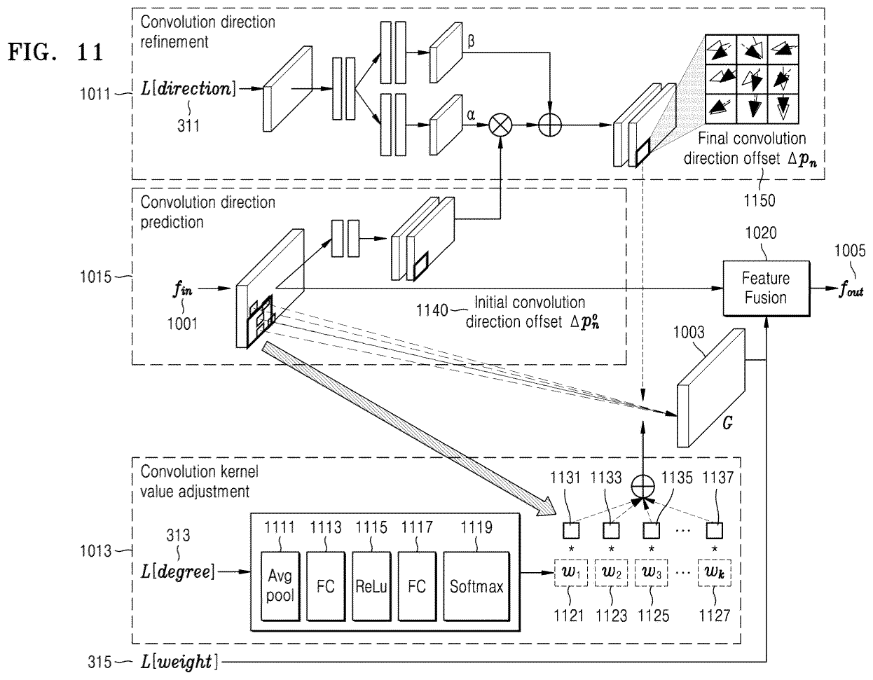

FIG. 11 illustrates detailed operations of a first convolution 910 operation according to embodiments of the disclosure.

According to embodiments, the adjusting 1013 of the value of the convolution kernel based on the degree information 313 of the trailing blur may include: obtaining convolution fusion weight information based on the degree information 313 of the trailing blur; and obtaining the adjusted value of the convolution kernel based on the convolution fusion weight information and the convolution kernel to be adjusted. The specific operation of the convolution kernel value adjustment is illustrated in 1013 in FIG. 11. As shown in 1013 in FIG. 11, the input for the convolution kernel value adjustment is the degree information L[degree]313 of the trailing blur obtained by the Coma prediction. Computation is performed on the L[degree]313 through a multi-layer fully connected network to output the convolution fusion weight information. For example, L[degree]313 passes sequentially through an average pooling layer 1111, Fully Connected Layer (FC) 1113, 1117, ReLu 1115, and Softmax 1119 to obtain a set of convolution fusion weights w₁ 1121 to wₖ 1127. After obtaining the convolution fusion weight information, the adjusted value of the convolution kernel may be obtained based on the convolution fusion weight information and the convolution kernel to be adjusted.

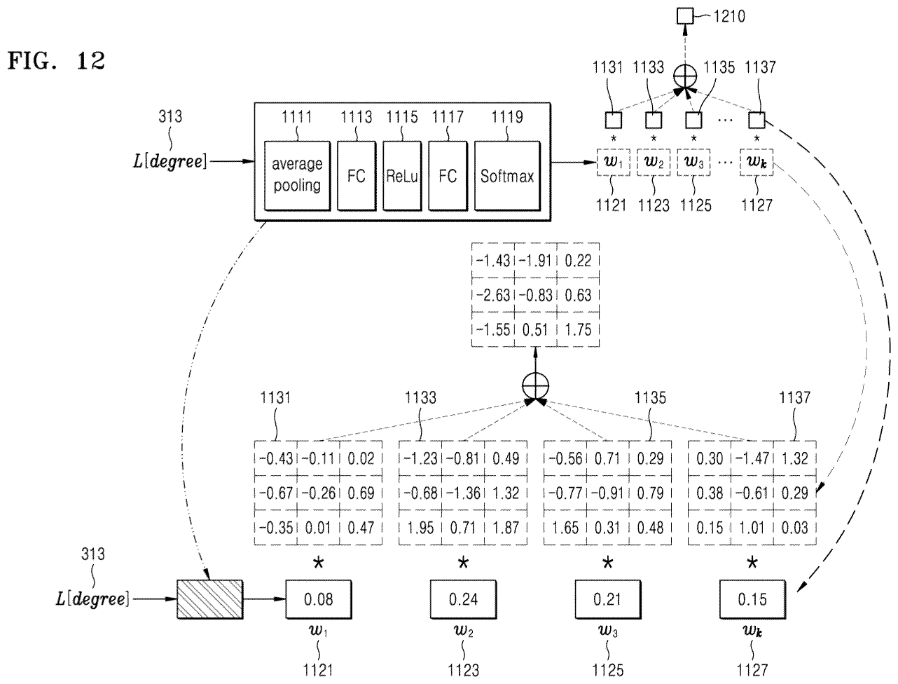

FIG. 12 illustrates an example of convolution kernel value adjustment according to embodiments of the disclosure. According to embodiments, the value of the convolution kernel may include a weight and a bias of the convolution kernel. As shown in FIG. 12, the degree information L[degree]313 of the trailing blur passes through a fully connected network to predict a set of fusion weights w₁ 1121 to wₖ 1127. Subsequently, the set of weights may be performed calculation with the convolution kernel to be adjusted 1131 to 1137 based on the following formulae, to obtain the adjusted weight and bias of the convolution kernel.

$$\tilde{W} ( x ) = {\sum }_{i = 1}^{k} {w}_{i} ( x ) {W}_{i} , \tilde{B} ( x ) = {\sum }_{i = 1}^{k} {w}_{i} ( x ) {B}_{i}$$

$$s . t . 0 \leq {w}_{i} ( x ) \leq 1 , {\sum }_{i = 1}^{k} {w}_{i} ( x ) = 1$$

where Wᵢ, Bᵢ are the weight and bias of the convolution kernel to be adjusted, \tilde{W}, \tilde{B} are the adjusted weight and bias of the convolution kernel, k is the number of convolution kernels, and x is the input feature.

In addition to including adjusting the value of the convolution kernel based on the degree information 313 of the trailing blur, the first convolution 910 operation according to embodiments includes adjusting a shape of the convolution kernel based on the direction information 311 of the trailing blur. According to embodiments, adjusting the shape of the convolution kernel based on the direction information 311 of the trailing blur includes: estimating an initial convolution direction offset 1140 of the convolution kernel based on the feature on which the first convolution 910 operation is to be performed, determining a final convolution direction offset based on the estimated initial convolution direction offset and the direction information of the trailing blur, and adjusting the shape of the convolution kernel based on the final convolution direction offset.

Referring back to FIG. 11, an initial convolution direction offset

$$Δ {p}_{n}^{o}$$

1140 of the convolution kernel may be estimated based on a feature on which the first convolution 910 operation is to be performed (also referred to as an input feature fin 1001 of the first convolution operation), which may be referred to as “convolution direction estimation”, as shown in 1015 in FIG. 11.

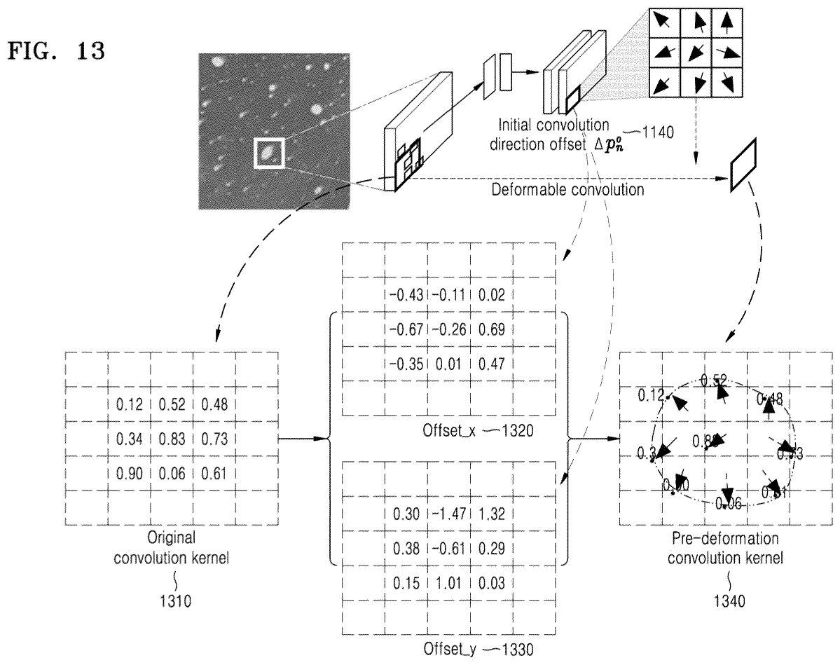

FIG. 13 illustrates an example of convolution direction estimation according to embodiments of the disclosure. As shown in FIG. 13, an initial convolution direction offset 1140 of a convolution kernel may be estimated based on the input feature fin 1001 of the first convolution operation, and the initial convolution direction offset 1140 may include a horizontal offset offset_x 1320 and a vertical offset offset_y 1330. Subsequently, a convolution kernel to be adjusted (e.g., the original convolution kernel 1310) may be shifted based on the estimated initial convolution direction offset to change a shape of the convolution kernel, thereby obtaining a predeformed convolution kernel 1340 initially adapted to the input feature.

Returning back to FIG. 10, after obtaining the initial convolution direction offset by the convolution direction estimation, convolution direction fine-tuning (refinement 1011) may be further performed based on the initial convolution direction offset and the direction information of the trailing blur, and the convolution direction fine-tuning is shown in 1011 in FIG. 11. As shown in the red box in FIG. 11, the input for the convolution direction fine-tuning includes an initial convolution direction offset

$$Δ {p}_{n}^{o}$$

1140 and the direction information L[direction]311 of the trailing blur obtained from the Coma prediction. The initial convolution direction offset

$$Δ {p}_{n}^{o}$$

140 may be fine-tuned based on the direction information L[direction]311 of the trailing blur to obtain a final convolution direction offset Δp_{N} 1150.

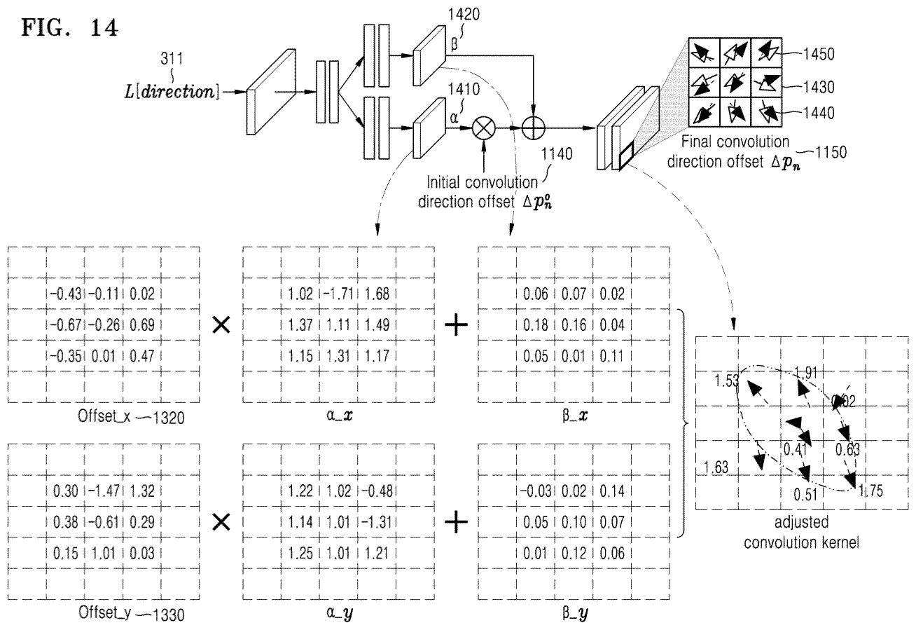

FIG. 14 illustrates an example of convolution direction fine-tuning according to embodiments of the disclosure. As shown in FIG. 14, convolution computations of two branches may first be performed on the direction information L[direction]311 of the trailing blur to output size vectors α1410 and β1420, respectively, where α1410 and β1420 denote size scaling and bias, respectively. As shown in FIG. 14, scaling and biasing calculations are performed on the horizontal offset offset_x 1320 and the vertical offset offset_y 1330 included in the input initial convolution direction offset 1140 to obtain a fine-tuned convolution direction offset (e.g., the final convolution direction offset Δp_{N} 1150), which may be computed, for example, according to the following equation:

$$Δ {p}_{n} = ( α * Δ {p}_{n}^{o} + β )$$

Subsequently, the shape of the convolution kernel may be adjusted according to the final convolution direction offset 1150.

In FIG. 14, the convolution kernel 1430 is the shape of the fine-tuned convolution kernel, the black filled arrow 1440 denotes the offset direction of the corresponding position of the fine-tuned convolution kernel, and the white filled arrow 1450 denotes the initial convolution direction offset 1140 computed by the convolution direction estimation shown in FIG. 13, from which it may be seen that the shape of the fine-tuned convolution kernel is more closely matched to the input feature.

Returning back to make reference to FIGS. 10 and 11, after adjusting the value of the convolution kernel based on the degree information 313 of the trailing blur and adjusting the shape of the convolution kernel based on the direction information 311 of the trailing blur, the first convolution feature may be obtained by performing a convolution operation using the adjusted convolution kernel on a feature on which the first convolution 910 operation is to be performed.

As shown in FIGS. 10 and 11, the adjusted convolution kernel is applied to the feature on which the first convolution 910 operation is to be performed (e.g., the input feature fin 1001) to obtain the first convolution feature G 1003. Usually, the trailing blur problem occurs mainly in the edge area of the whole image and less in the center area, and in the same color area, the trailing blur is more obvious in the high-frequency area with complex texture and less obvious in the low-frequency area. Therefore, it may be necessary to balance the center and edge areas, and the high-frequency and low-frequency areas. To this end, as shown in FIGS. 10 and 11, an output feature fₒᵤₜ 1005 of the first convolution operation is obtained by fusing the input feature fin 1001 and the first convolution feature G 1003 based on the probability information L[weight]315 of the trailing blur. By fusing the input feature fin 1001 and the first convolution feature G 1003 based on the probability information 315 of the trailing blur, it is possible to keep the trailing blur-free area clear and unchanged while resolving the trailing blur.

For example, the output feature fₒᵤₜ 1005 may be obtained by fusing the input feature fin 1001 and the first convolution feature G 1003 with the following equation:

$${f}_{o u t} = L [ weight ] * {f}_{i n} + ( 1 - L [ weight ] ) * G$$

Above, the first convolution operation according to embodiments of the disclosure has been described with reference to FIGS. 10 to 14.

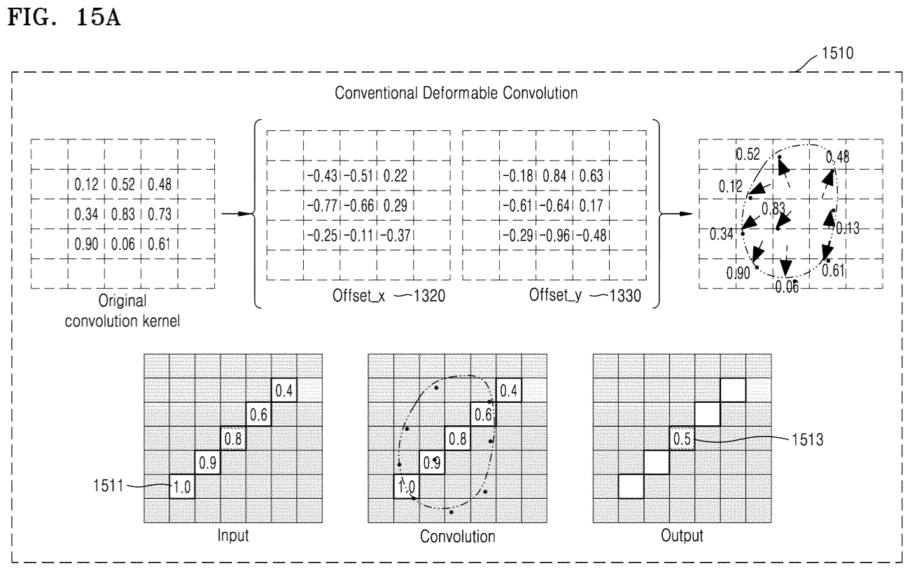

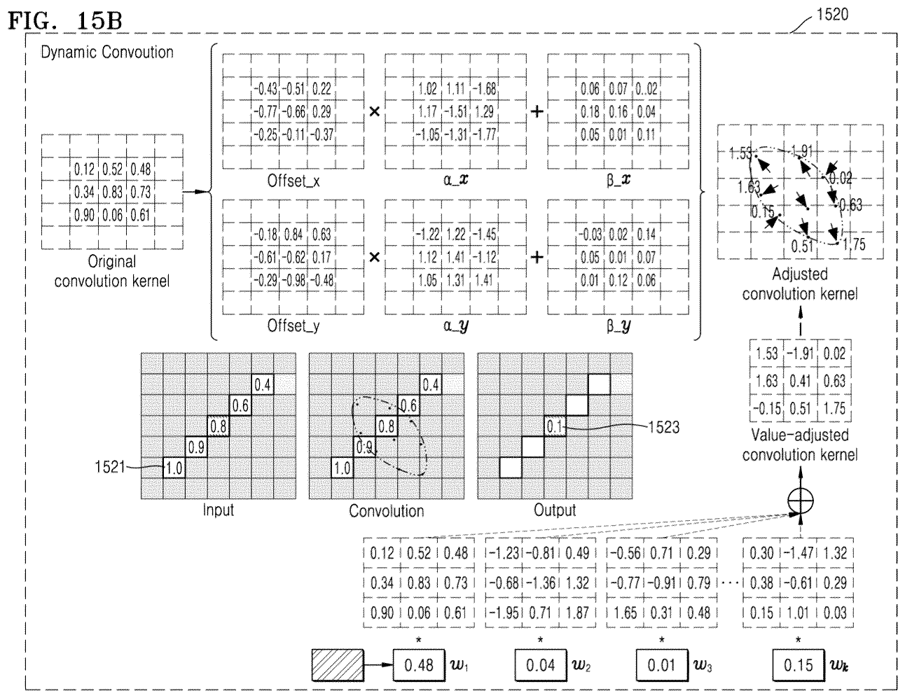

FIG. 15A and FIG. 15B illustrates a comparison of employing a first convolution 910 operation according to embodiments of the disclosure with employing a conventional deformable convolution 1510, according to embodiments of the disclosure. As shown in FIG. 15 A, the input is a point with a value of 1.0 1511, but which has a directional trailing blur. The conventional deformable convolution 1510 (convolution direction estimation as described above with reference to FIG. 13) only adjusts the shape of the convolution kernel according to the image feature, but due to its lack of the trailing blur state information, it does not remove the trailing blur well, e.g., the trailing blur of 0.5 1513 cannot be removed well. However, as shown in FIG. 15B, the first convolution 910 operation (e.g., dynamic convolution 1520) according to embodiments of the disclosure may adjust the shape of the convolution kernel based on the trailing blur state information 310 and adjust the value of the convolution kernel based on the trailing blur state information 310, and thus, the trailing blur may be adaptively reduced. For example, as shown in FIG. 15B, the trailing blur of the point of 1.0 1521 is reduced to 0.1 1523, which achieves better results than the conventional deformable convolution 1510.

At least one of the feature encoding operation of the encoder 810, the simulate aperture adjustment 820 operation, and the feature decoding operation of the decoder 830 may include the first convolution operation, as described above with reference to FIGS. 8 and 9. The first convolution 910 operations included in the feature encoding operation, the simulate aperture adjustment operation, and the feature decoding operation may all be performed in the manner of the first convolution 910 operation described above, and therefore, the first convolution 910 operations involved in the processes of the feature encoding operation of the encoder 810, the simulate aperture adjustment 820 operation, and the feature decoding operation of the decoder 830 will not be described hereinafter when these operations are described.

In the following paragraphs, the encoding operation, the simulate aperture adjustment 820 operation, and the feature decoding operation are described, respectively.

According to embodiments, feature encoding may be performed on the input image to obtain the encoded feature based on the trailing blur state information 310. For example, the performing of the feature encoding on the input image based on the trailing blur state information 310 to obtain the encoded feature may include: at least one of performing a second convolution 920 operation on the input image 401, and performing a first convolution 910 operation on a feature obtained by the second convolution 920 operation based on the trailing blur state information 310 to obtain the encoded feature; or performing the first convolution 910 operation on the input image 401 to obtain the encoded feature. The convolution kernel is not adjusted in the second convolution 920 operation (also referred to as a “static convolution operation” or a “regular convolution operation”), and because the convolution kernel is not adjusted, it consumes less computation resources than the first convolution 910 operation. Although the first convolution 910 operation consumes more computation resources than the second convolution 920 operation, as described above, better trailing blur removal result can be obtained using the first convolution 910 operation because the convolution kernel is adjusted. If a better trailing blur removal effect is required, the encoded feature may be obtained based entirely on the first convolution 910 operation, whereas if the balance between the computation resources and the trailing blur removal effect is considered, the second convolution 920 operation and the first convolution 910 operation may be used in combination, where the second convolution 920 operation is performed first and then the first convolution 910 operation is performed.

As shown in FIG. 8, the input to the encoder is the input image 401 and the trailing blur state information 310 obtained by the Coma prediction module 400. For example, as shown in FIG. 9, the encoded feature may be obtained by performing the second convolution 920 operation (indicated by 920 in FIG. 9) on the input image 401 and performing the first convolution 910 operation (indicated by 910 box in FIG. 9) based on the trailing blur state information 310, at different sizes.

Subsequently, the simulate aperture adjustment 820 operation 930 (indicated by 930 box in FIG. 9) may be performed on the encoded feature based on the trailing blur state information 310 and a preset aperture mapping pool 840 to obtain an aperture-adjusted feature. The “simulate aperture adjustment operation” is also referred as “aperture simulate adaptation”.

Another reason for trailing blur is due to the optical hardware system, but as mentioned above, removing the trailing blur by improving the hardware is costly and leads to more serious other imaging quality problems. In response to this, the disclosure proposes to simulate aperture adjustment in a hidden space (also referred to as a feature space) to obtain a feature with local optimal aperture effect and without the four-corner blur, and then to obtain a high-quality output image based on such the aperture-adjusted feature.

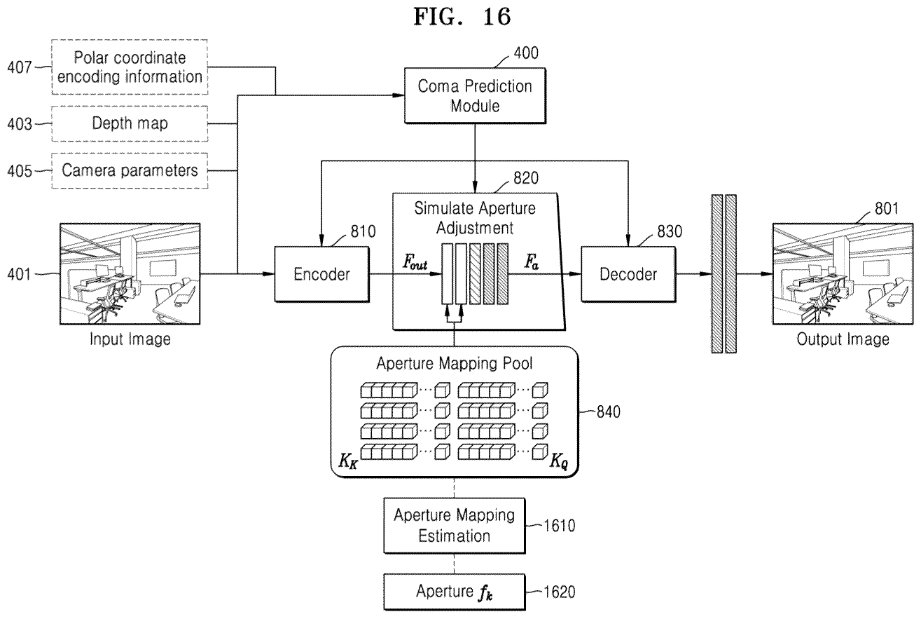

In the following paragraphs, the simulate aperture adjustment 820 operation will be described with reference to FIGS. 16 to 20.

First, as shown in FIG. 16, the input for the simulate aperture adjustment 820 operation is an encoded feature output by the encoder (denoted as Fₒᵤₜ in FIG. 16), trailing blur state information 310 from the Coma prediction, and a preset aperture mapping pool 840. By using the aperture mapping pool 840 and the trailing blur state information 310 to guide the encoded feature for the simulation of different aperture effects, a feature with local optimal aperture characteristics and without the four-corner blur (e.g., the aperture-adjusted feature, which is denoted as Fₐ in FIG. 16) may be obtained.

Since the preset aperture mapping pool 840 is used in the simulate aperture adjustment 820 operation, the establishment of the aperture mapping pool 840 is first described for ease of understanding. According to embodiments, as shown in FIG. 16, the preset aperture mapping pool 840 is obtained by performing aperture mapping estimation 1610 (also referred to as “modulation parameter prediction”) based on different apertures fₖ 1620, and the aperture mapping pool 840 may include aperture mapping parameters corresponding to a plurality of candidate aperture parameters, e.g., the aperture mapping parameters K_{K} and K_{Q} corresponding to the aperture fₖ 1620. For example, the aperture mapping parameters K_{K} and K_{Q} may be convolution kernels, but are not limited thereto.

According to embodiments, the aperture mapping parameters corresponding to the plurality of candidate aperture parameters are obtained by: obtaining an image captured at a predetermined aperture and each candidate aperture parameter; predicting, based on each candidate aperture parameter, the aperture mapping parameter corresponding to each candidate aperture parameter using a pre-trained prediction model; modulating an image feature of the image captured at the predetermined aperture based on the aperture mapping parameter corresponding to each candidate aperture parameter, and obtaining a target image corresponding to each candidate aperture parameter based on the modulated image feature.

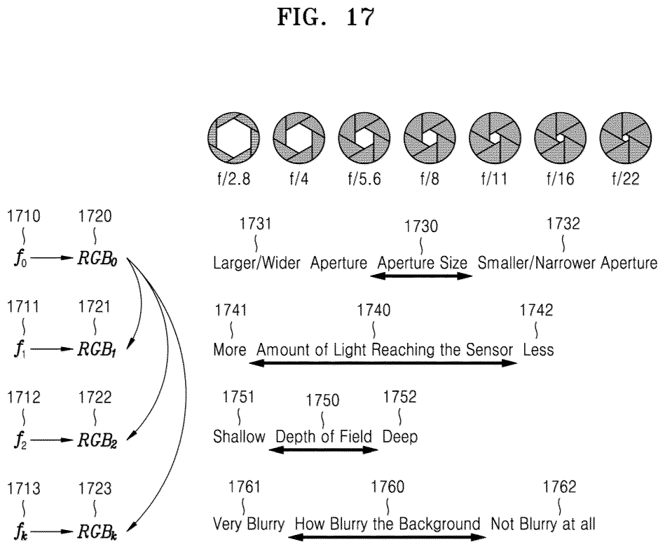

As shown in FIG. 17, in an image signal processing system, different RGB images may be obtained through image signal processing for different apertures, and a mapping from an image RGB₀ 1720 captured at a predetermined aperture f₀ 1710 to an image RGBₖ 1723 at a candidate aperture fₖ 1713 may be established. As shown in FIG. 17, the smaller/narrower the aperture size is, the less the amount of light that reaches the image sensor is, the deeper the depth of field is, and the less blur the background is, and conversely, the larger/wider the aperture size is, the more the amount of light that reaches the image sensor is, the shallower the depth of field is, and the more blur the background is.

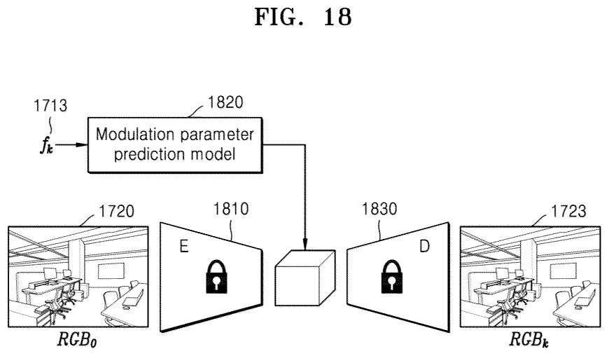

FIG. 18 illustrates a block diagram of establishing an aperture mapping pool according to embodiments of the disclosure. As shown in FIG. 18, in a case where the input is a candidate aperture fₖ 1713, a modulation parameter prediction model 1820 may be utilized to predict a aperture mapping parameter corresponding to the candidate aperture fₖ 1713. In a case where an image RGB₀ 1720 captured at a predetermined aperture f₀ 1710 and an image RGBₖ 1723 captured at the candidate aperture fₖ 1713 are given, and parameters of an encoder (E) 1810 and a decoder (D) 1830 are fixed, the image feature output by the encoder 1810 is modulated using the aperture mapping parameter corresponding to the fₖ 1713 predicted by the modulation parameter prediction model 1820 based on the fₖ 1713, so that the decoder may obtain the image RGBₖ 1723 by decoding the modulated image feature.

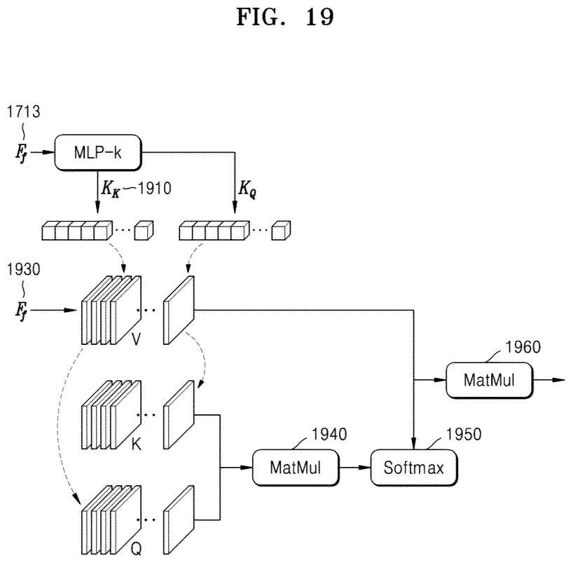

FIG. 19 illustrates a detailed process of establishing an aperture mapping pool according to embodiments of the disclosure. To estimate the mapping between different apertures, a public Variational Autoencoder (VAE) model with pre-trained weights may be used. The mapping between different apertures may be represented in various ways, e.g., the aperture mapping parameter may be represented by a convolution kernel. As shown in FIG. 18, in a case that the encoder and decoder of the VAE are fixed, the aperture mapping parameters K_{K} 1910 and K_{Q} 1920 in the hidden space may be predicted by using an MLP as the modulation parameter prediction model 1820 based on fₖ 1713. Although the modulation parameter prediction model 1820 is illustrated as the MLP in the examples of FIG. 18 and FIG. 19, the modulation parameter prediction model 1820 is not limited to the MLP, but may be various types of prediction models. Furthermore, the mapping of each aperture is independent of each other.

As shown in FIGS. 18 and 19, the aperture mapping pool may be established according to the following operations:

Operation 1, a candidate aperture parameter fₖ 1713 is selected. The modulation parameter prediction model 1820 is utilized to predict an aperture mapping parameter corresponding to the candidate aperture parameter fₖ 1713. The modulation parameter prediction model 1820 may be set as desired, for example, it may be a fully connected network. Also, the mapping parameter output by the modulation parameter prediction model 1820 may be set as desired, for example, may be convolution kernel weights.

Operation 2, the VAE model is used, the input image is an image RGB₀ 1720 captured at a predetermined aperture f₀ 1710, and the output image is a target image RGBₖ1723 captured at the candidate aperture parameter fₖ 1713. The parameters of the encoder (E) 1810 and the decoder (D) 1830 are fixed, and parameters of the modulation parameter prediction model 1820 are adjusted continuously, so that the target image captured at the candidate aperture parameter fₖ 1713 may be obtained by decoding the output feature F obtained after the modulation of the input feature is achieved by performing a hidden space feature transformation on the input feature F_{f} 1930 according to the following equation using mapping parameters K_{K} 1910 and K_{Q} 1920 output by the modulation parameter prediction model 1820 obtained by.

$$F = Softmax ( \frac{Q {K}^{T}}{\sqrt{d}} ) V$$

$$K = f ( {F}_{f} , {K}_{K} )$$

$$Q = f ( {F}_{f} , {K}_{Q} )$$

$$V = {F}_{f}$$

where K_{K} and K_{Q} are the parameters output by the modulation parameter prediction model, d is a normalization parameter, f(*) is a convolution operation, F_{f} is the input feature, F is the output feature, and Softmax(*) is an activation function. For example, if the input feature F_{f} has N channels, K_{K} and K_{Q} may be of size [3*3*N*N]. As shown in FIG. 19,

$$F = Softmax ( \frac{Q {K}^{T}}{\sqrt{d}} ) V$$

indicates that firstly,

$$\frac{Q {K}^{T}}{\sqrt{d}}$$

is realized by a matrix multiplication function MatMul 1940, and secondly,

$$Softmax ( \frac{Q {K}^{T}}{\sqrt{d}} )$$

is obtained after Softmax 1950, and then

$$Softmax ( \frac{Q {K}^{T}}{\sqrt{d}} ) V$$

is realized by MatMul 1960, thereby obtaining the output feature F.

Operation 3, the aperture mapping parameters corresponding to the candidate aperture parameters are saved and added to the aperture mapping pool 840. If the calculation of all candidate aperture mapping parameters is completed, it proceeds to operation 4; if not, it proceeds to operation 1 and starts the calculation of the next aperture parameter.

Operation 4, the process ends and the aperture mapping pool 840 is saved.

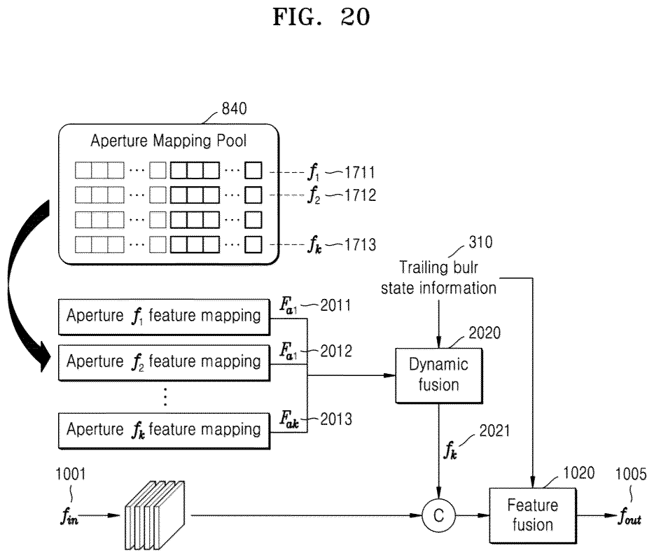

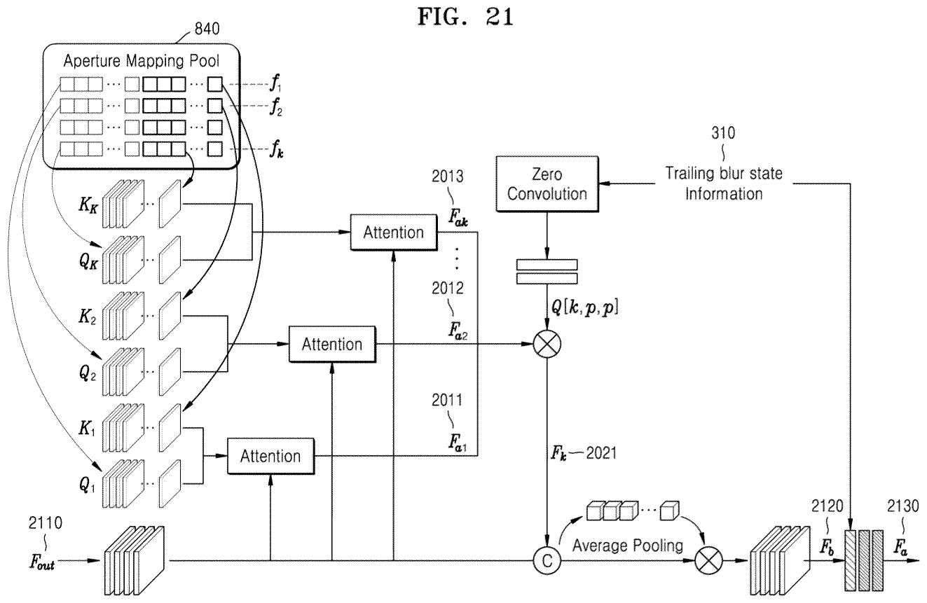

In a case where the aperture mapping pool 840 is pre-established, as shown in FIGS. 9 and 16, the simulate aperture adjustment 820 operation may be performed on the encoded feature based on the trailing blur state information 310 and the pre-established aperture mapping pool 840 to obtain the aperture-adjusted feature. The simulate aperture adjustment operation is described below with reference to FIGS. 20 and 21.

According to embodiments, the performing of the simulate aperture adjustment operation on the encoded feature based on the trailing blur state information 310 and the preset aperture mapping pool 840 to obtain the aperture-adjusted feature may include: obtaining a plurality of aperture features corresponding to a plurality of candidate aperture parameters based on aperture mapping parameters corresponding to the plurality of candidate aperture parameters in the preset aperture mapping pool 840; predicting aperture feature fusion weights based on the trailing blur state information 310; fusing the plurality of aperture features based on the predicted aperture feature fusion weights to obtain a first fusion feature; fusing the encoded feature with the first fusion feature to obtain a second fusion feature; and obtaining the aperture-adjusted feature based on the second fusion feature. By the above operation, the aperture change may be simulated to remove the four-corner blur, and it is realized that the calculation of the aperture simulate adaptation is performed in the hidden space.

As shown in FIG. 20, it is assumed that a plurality of candidate aperture parameters in a preset aperture mapping pool 840 are f₁ 1711 to fₖ 1713, aperture feature mapping may be performed on aperture mapping parameters corresponding to f₁ 1711 to fₖ 1713, respectively, to obtain aperture features corresponding to each of the aperture mapping parameters, e.g., as shown in FIG. 21, a self-attention operation may be performed on the aperture mapping parameters corresponding to f₁ 1711 to fₖ 1713, respectively, to obtain aperture features Fₐ₁ 2011 to Fₐₖ 2013 corresponding to each of the aperture mapping parameters. The number of the aperture features is the same as the number of the candidate aperture parameters. The attention operation herein may be performed in the same manner as operation 2 above. After obtaining the aperture features corresponding to each of the plurality of candidate aperture parameters, dynamic fusion 2020 of the aperture features may be performed based on the trailing blur state information 310 output by the Coma prediction module 400. For example, as shown in FIG. 21, aperture feature fusion weights Q[k, p, p] are predicted by a convolution computation (e.g., a zero-convolution computation) based on the trailing blur state information 310, where k is the number of the candidate aperture parameters in the aperture mapping pool 840, and p is a spatial size for fusion. Subsequently, different aperture features Fₐ₁, Fₐ₂, . . . , Fₐₖ are fused according to the fusion weights Q to obtain the fusion feature Fₖ 2021 (the first fusion feature above). Through the aperture feature fusion, the purpose of obtaining continuous aperture effect using a discrete aperture mapping pool may be achieved.

Next, the input feature fₙ 1001 e.g., the encoded feature Fₒᵤₜ 2110 output from the encoder) is fused with the first fusion feature Fₖ 2021 obtained after the aperture feature fusion to obtain the output feature fₒᵤₜ 1005, e.g., the above second fusion feature (denoted as F_{b} 2120 in FIG. 21). For example, the encoded feature Fₒᵤₜ 2110 may first be performed feature splicing with the first fusion feature Fₖ 2021, and then, channel adaptation fusion is performed using global average pooling and 1*1 convolution to obtain the second fusion feature F_{b} 2120. Finally, the aperture-adjusted feature Fₐ 2130 is obtained based on the second fusion feature F_{b} 2120.

According to embodiments, the obtaining of the aperture-adjusted feature based on the second fusion feature 2120 includes: at least one of performing a first convolution 910 operation on the second fused feature based on the trailing blur state information 310, and performing a second convolution 920 operation on a feature obtained by the first convolution 910 operation to obtain the aperture-adjusted feature; or performing the first convolution 910 operation on the second fused feature based on the trailing blur state information 310 to obtain the aperture-adjusted feature.

As mentioned above in the description with reference to FIGS. 8 and 9, in an embodiment, the simulate aperture adjustment 820 operation may also include the first convolution 910 operation mentioned above. In this case, after obtaining the second fusion feature F_{b} 2120, the first convolution 910 operation may be performed on the second fusion feature F_{b} 2120 based on the trailing blur state information 310 to obtain the aperture-adjusted feature Fₐ 2130. Or, in an embodiment, as illustrated in FIG. 21, after obtaining the second fusion feature F_{b} 2120, the first convolution 910 operation may be performed on the second fusion feature F_{b} 2120 based on the trailing blur state information 310 and the second convolution operation 920 is performed on the feature obtained by the first convolution 910 operation to obtain the aperture-adjusted feature Fₐ 2130. In the above, details of the first convolution 910 operation have been described, and will not be repeated here.

Above, the simulate aperture adjustment 820 operation has been described, and returning back to make reference to FIGS. 8 and 9, after the aperture-adjusted feature has been obtained by the simulate aperture adjustment 820 operation, the decoder may be utilized to decode the aperture-adjusted feature to obtain a high-quality output image. As shown in FIGS. 8 and 9, the feature decoding may be performed under the guidance of the trailing blur state information 310 obtained by the Coma prediction, to obtain the output image, e.g., the feature decoding operation is performed on the aperture-adjusted feature based on the trailing blur state information 310 to obtain the output image.

According to embodiments, the performing of the feature decoding operation on the aperture-adjusted feature based on the trailing blur state information 310 to obtain the output image may include: at least one of performing a second convolution 920 operation on the aperture-adjusted feature, and performing a first convolution 910 operation on a feature obtained by the second convolution 920 operation based on the trailing blur state information 310, and obtaining the output image based on a feature obtained by the first convolution 910 operation; or, performing the first convolution 910 operation on the aperture-adjusted feature based on the trailing blur state information 310, and obtaining the output image based on a feature obtained by the first convolution 910 operation. For example, as shown in the schematic diagram of the operations in the decoder illustrated in FIG. 9, the second convolution 920 operation (indicated by 920 in the decoder box) may be performed at different sizes on the aperture-adjusted feature obtained by aperture simulate adaptation (i.e., simulating the aperture adjustment) and the first convolution 910 operation (indicated by the 910 in the decoder box) is further performed on the feature obtained by the second convolution 920 operation, and finally, a high quality output image may be obtained by performing on the feature obtained by the first convolution 910 operation. The details of the first convolution operation have been described above and will not be repeated herein.

Above, the method performed by an electronic apparatus according to embodiments of the disclosure has been described. The method according to embodiments of the disclosure is capable of improving the trailing blur in the input image by taking into account the characteristics of the trailing blur without any hardware change, thereby obtaining a higher quality output image.

The method according to embodiments of the disclosure may be applied in a variety of scenarios. A brief description is made for example scenarios to which the method according to embodiments of the disclosure may be applied.

For example, the method according to embodiments of the disclosure may be applied in a camera capturing scenario and a photo album image editing scenario.

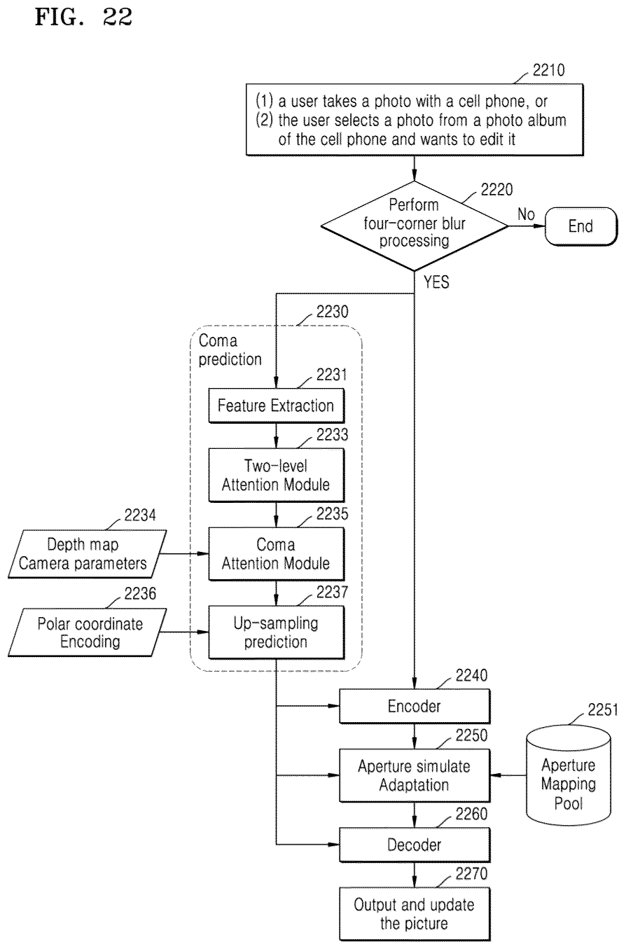

As shown in FIG. 22, in a scenario where a user takes a photo with a cell phone or the user selects a photo from a photo album of the cell phone and wants to edit it 2210, it may first be determined whether four-corner blur processing is performed 2220, and if not (N), it ends, and if it is yes (Y), four-corner blur removal is performed using the method according to embodiments of the disclosure to output an updated photo. As shown in FIG. 22, the trailing blur state information may be obtained based on the Coma prediction 2230, which is obtained by first performing feature extraction 2231 on the captured photo or the selected photo from the photo album, and then going through the two-level attention module 2233, the Coma attention module 2235, and the up-sampling prediction 2237 in turn. How to obtain the trailing blur state information has been described above and will not be repeated here. After obtaining the trailing blur state information, it may be utilized to guide the operations of the encoder 2240, the aperture simulate adaptation 2250 and the decoder, 2260 respectively, to finally output and update the photo 2270.

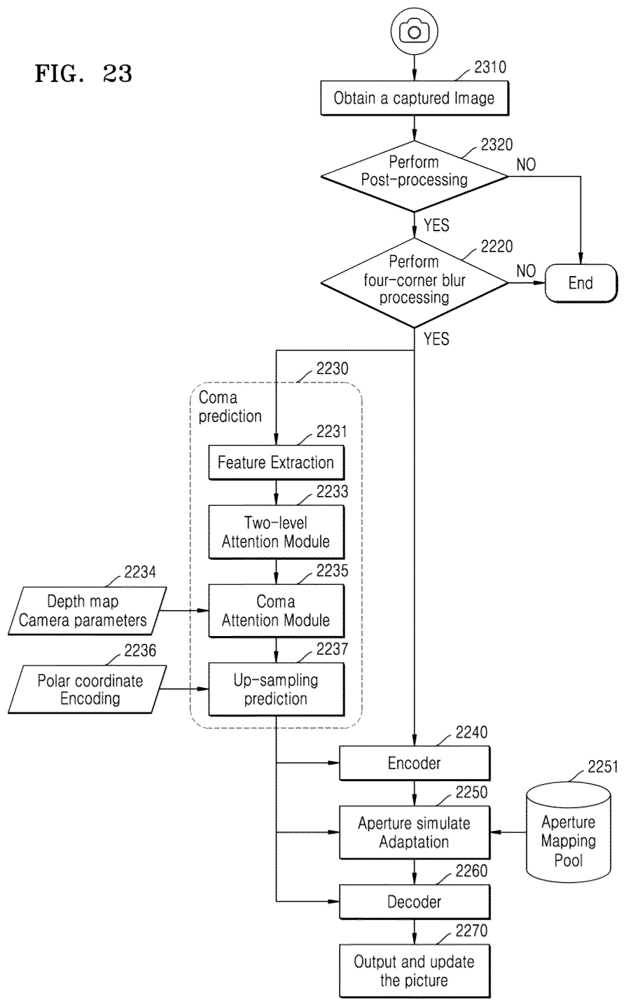

FIG. 23 illustrates an example where a method according to embodiments of the disclosure is applied to a camera capturing scenario. As shown in FIG. 23, after acquiring a captured image obtained through the camera 2310, it may first determine whether post-processing is performed 2320, and if not (N), it ends, otherwise it further determines whether four-corner blur processing 2220 is performed, and if not (N), it ends, otherwise the four-corner blur is removed by utilizing the method according to embodiments of the disclosure.

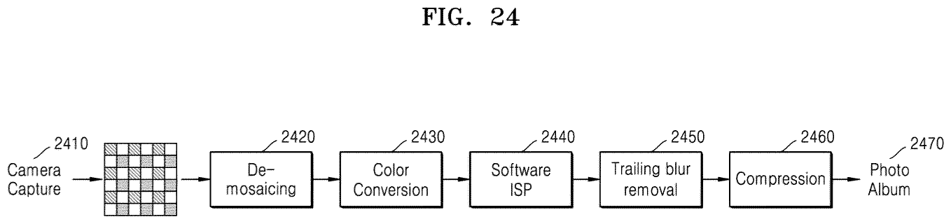

FIG. 24 illustrates an example where a method according to embodiments of the disclosure is applied to a camera capturing scenario. For example, as shown in FIG. 24, after obtaining an image 2410 by an image sensor, a de-mosaicing 2420 process may be performed first, then a color conversion 2430 may be performed, and further software image signal processing (ISP) 2440 may be performed, after which trailing blur removal 2450 may be performed utilizing the method according to the disclosure, and finally a compression 2460 may be performed on the image after the trailing blur removal is performed, and the compressed image may be stored in a photo album 2470. After performing the trailing blur removal utilizing the method according to the disclosure, the trailing blur in the image is effectively improved.

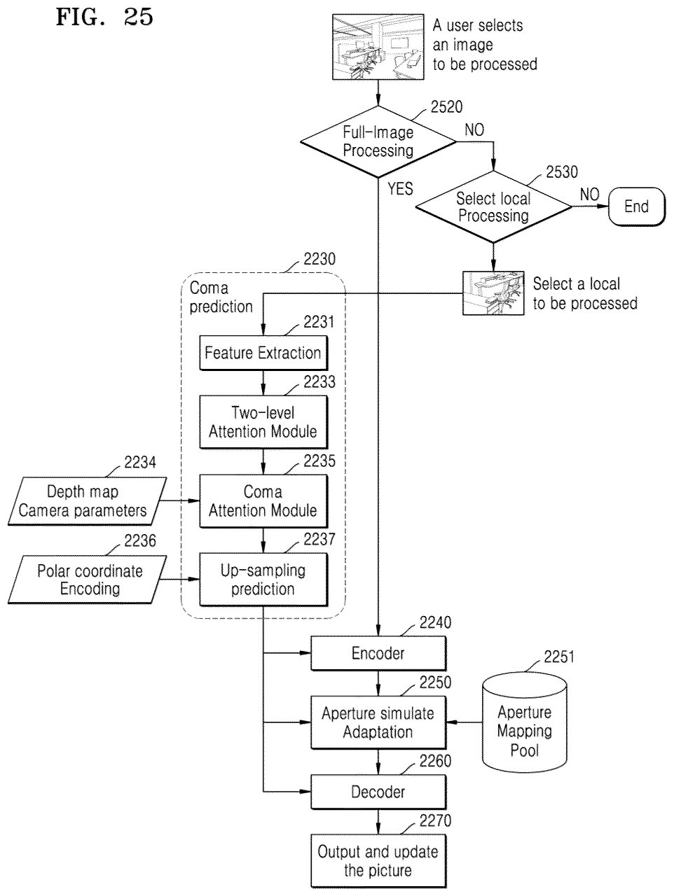

FIG. 25 illustrates an example where a method according to embodiments of the disclosure is applied to a photo album image editing scenario. As shown in FIG. 25, a user may select an image to be processed 2510 from the photo album, and may select whether to perform full-image processing 2520 or local processing 2530 according to an expectation, and either full-image processing or local processing 2540 may use the method according to embodiments of the disclosure to perform trailing blur removal, and the specific removal process has already been described above, and will not be repeated herein. In an embodiment, either the trailing blur removal may be performed by applying the method according to embodiments of the disclosure to all of the images included in the photo album, or the trailing blur removal may be performed only on the image selected by the user.

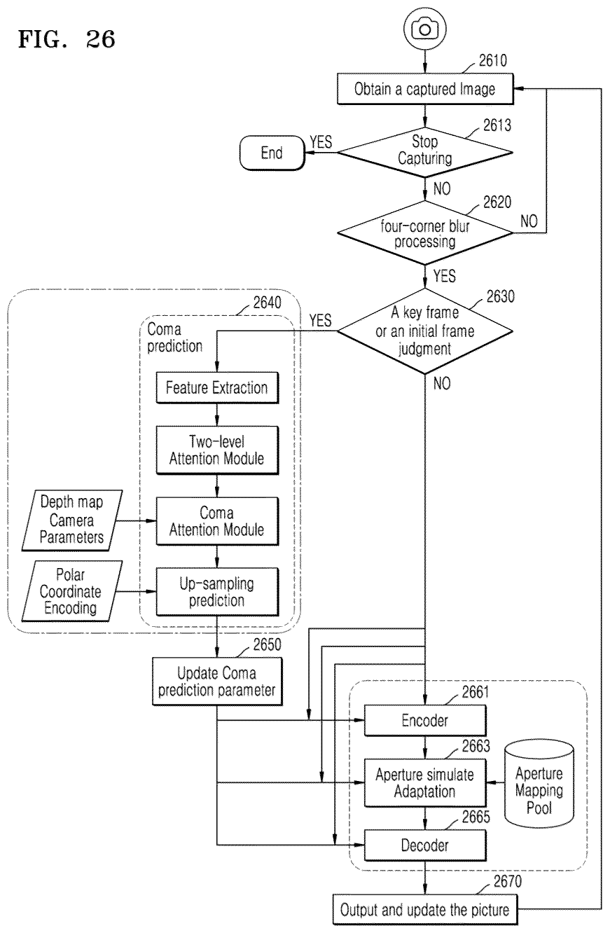

FIG. 26 illustrates an example where a method according to embodiments of the disclosure is applied to a video recording scenario. As shown in FIG. 26, when a video is recorded, this scheme may be extended taking into account real-time processing issues. For example, a key frame or an initial frame judgment 2630 is performed, and if it is the key frame or the initial frame, a parameter for the Coma prediction 2640 (e.g., the trailing blur state information) is updated; if it is not the key frame, the trailing blur state information predicted in the previous frame is used for the computation of the other modules in order to improve the computation efficiency.

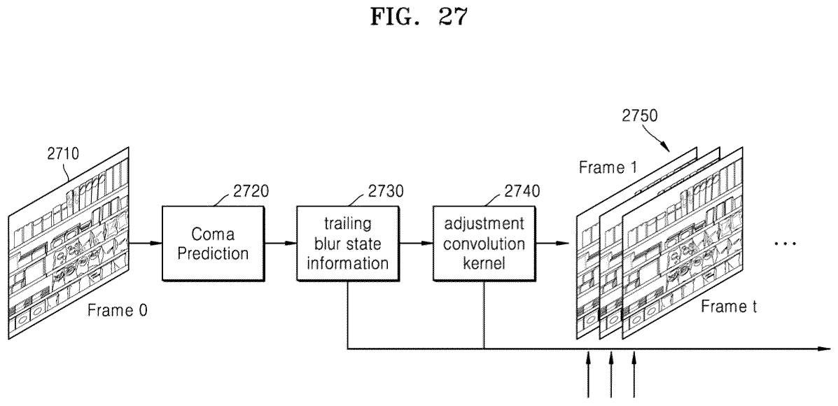

FIG. 27 illustrates an example where a method according to embodiments of the disclosure is applied to a video recording scenario. For example, when capturing a video, it is a common capturing technique for a character to move in and out of the frame, and when the character is located at the edge of the frame, poor image quality is obtained due to trailing blur, which seriously affects the viewing effect of the video. The method of embodiments of the disclosure may be utilized to effectively remove the trailing blur that occurs when the character is located at the edge of the frame. For example, for each frame, after performing the Coma prediction 2720 to obtain its trailing blur state information 2730, a convolution kernel may be adjusted based on the trailing blur state information, and a convolution operation may be performed using the adjusted convolution kernel 2740.

In an embodiment, as shown in FIG. 27, in order to improve the video processing speed, in a case where the change of the image of frame t is not large, after performing the Coma prediction 2720 on frame₀ to obtain the trailing blur state information 2730 and obtaining the first convolution kernel based on the trailing blur state information 2730, the trailing blur state information 2730 and the first convolution kernel obtained based on frame₀ 2710 may be applied to the processing of frame₁ to frameₜ, so that the processing of frame₁ to frameₜ may be performed at a faster speed to obtain a higher quality video.

In the foregoing paragraphs, some application scenarios of the method according to embodiments of the disclosure have been described, however, the method according to embodiments of the disclosure is not limited to being applied to the above example scenarios, but may be applied to any scenario in which trailing blur removal is required.

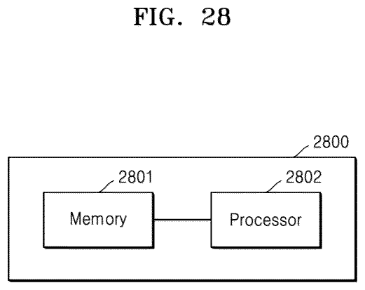

In the following paragraphs, the electronic apparatus according to embodiments of the disclosure is briefly described. FIG. 28 is a block diagram illustrating an electronic apparatus according to embodiments of the disclosure. Referring to FIG. 28, the electronic apparatus 2800 may include a memory 2801 and a processor 2802, wherein the processor 2802 is coupled to the memory 2801 and configured to perform the method described above.

According to embodiments of the disclosure, there is provided a computer program product including computer programs/instructions, the computer programs/instructions, when being executed by a processor, implement the method described above.

In embodiments of the disclosure, an electronic apparatus includes at least one processor. In an embodiment, the electronic apparatus further includes at least one transceiver and/or at least one memory coupled to the at least one processor, wherein, the at least one processor is configured to perform the operations of the method provided in any alternative embodiment of the disclosure.

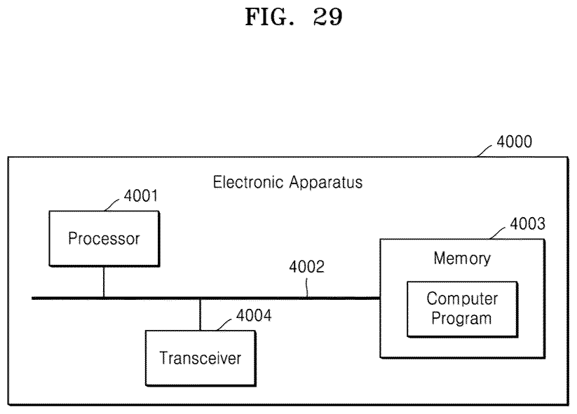

FIG. 29 illustrates a schematic diagram of a structure of an electronic apparatus applicable to an exemplary embodiment of the present application. As shown in FIG. 29, the electronic apparatus 4000 shown in FIG. 29 includes: a processor 4001 and a memory 4003. Wherein the processor 4001 and the memory 4003 are coupled, e.g., through a bus 4002. In an embodiment, the electronic apparatus 4000 may further include a transceiver 4004 which may be used for data interaction between the electronic apparatus and other electronic apparatuses, such as transmitting of data and/or receiving of data. It should be noted that, each of the processor 4001, the memory 4003, and the transceiver 4004 is not limited to one in a practice application, and the structure of the electronic apparatus 4000 does not constitute a limitation of the embodiments of the disclosure. In an embodiment, the electronic apparatus may be the first network node, the second network node, or the third network node.

The processor 4001 may be a Central Processing Unit (CPU), general purpose processor, Digital Signal Processor (DSP), Application Specific Integrated Circuit (ASIC), Field Programmable Gate Array (FPGA) or other programmable logic device, transistor logic device, hardware part, or any combination thereof. It may implement or perform various exemplary logic boxes, modules, and circuits described in conjunction with the disclosed contents of the disclosure. The processor 4001 may also be a combination that implements computing functions, such as a combination containing one or more microprocessors, a combination of a DSP and a microprocessor, and the like.

The bus 4002 may include a pathway to transfer information between the above components. The bus 4002 may be a Peripheral Component Interconnect (PCI) bus or an Extended Industry Standard Architecture (EISA) bus, and the like. The bus 4002 may be classed as an address bus, a data bus, a control bus, and the like. For ease of representation, only one bold line is shown in FIG. 29, but it does not mean that there is only one bus or one type of bus.

The memory 4003 may be a Read Only Memory (ROM) or other types of static storage apparatuses that can store static information and instructions, a Random Access Memory (RAM) or other types of dynamic storage apparatuses that can store information and instructions, may be an Electrically Erasable Programmable Read Only Memory (EEPROM), Compact Disc Read Only Memory (CD-ROM) or other optical disc storages, an optical disc storage (including a compressed disc, laser disc, optical disc, digital universal disc, Blu-ray disc, etc.), a disk storage medium, other magnetic storage apparatuses, or any other medium that can be used to carry or store computer programs and can be read by a computer, it is not limited herein.

The memory 4003 is used to store computer programs or executable instructions for performing the embodiments of the disclosure, and is controlled for execution by the processor 4001. The processor 4001 is used to execute the computer programs or executable instructions stored in the memory 4003 to implement the operations shown in the preceding method of the embodiments.

An embodiment of the disclosure provides a computer readable storage medium storing computer programs or instructions, the computer programs or instructions, when being executed by at least one processor may perform or implement the operations in the preceding method of the embodiments and corresponding contents.

An embodiment of the disclosure provides a computer program product including computer programs, the computer programs, when being executed by a processor, may implement the operations shown in the preceding method of the embodiments and corresponding contents.

The terms “first”, “second”, “third”, “fourth”, “1”, “2” and the like (if exists) in the specification and claims of the disclosure and the above drawings are used to distinguish similar objects, and need not be used to describe a specific order or sequence. Data used as such may be interchanged in appropriate situations, so that the embodiments of the disclosure described here may be implemented in an order other than the illustration or text description.

Although each operation is indicated by an arrow in the flowcharts of the embodiments of the disclosure, an implementation order of these operations is not limited to an order indicated by the arrows. Unless explicitly stated herein, in some implementation scenarios of the embodiments of the disclosure, the implementation operations in the flowcharts may be executed in other orders according to requirements. In addition, some or all of the operations in each flowchart may include a plurality of sub operations or stages, based on an actual implementation scenario. Some or all of these sub operations or stages may be executed at the same time, and each sub operation or stage in these sub operations or stages may also be executed at different times. In scenarios with different execution times, an execution order of these sub operations or stages may be flexibly configured according to a requirement, which is not limited by the embodiment of the disclosure.

The above text and accompanying drawings are provided as examples only to assist readers in understanding the disclosure. They are not intended and should not be interpreted as limiting the scope of the disclosure in any way. Although certain embodiments and examples have been provided, based on the content disclosed herein, it is apparent to those skilled in the art that, changes can be made to the illustrated embodiments and examples without departing from the scope of the disclosure, and other similar implementation methods based on the technical concepts of the disclosure also belongs to a protection scope of the embodiments of the disclosure.

The embodiments may be described and illustrated in terms of blocks, as shown in the drawings, which carry out a described function or functions. These blocks, which may be referred to herein as the two-level attention module, the Coma prediction module or the like may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

According to an embodiment of the disclosure, the method performed by an electronic apparatus is provided. The method may include obtaining position information of an object in an input image. The method may include predicting trailing blur state information of the input image, based on the position information and the input image. The method may include obtaining an output image by performing processing on the input image, based on the predicted trailing blur state information.

According to an embodiment of the disclosure, the method may include obtaining an image feature of the input image by performing feature extraction on the input image. The method may include obtaining a trailing blur feature of the input image based on the image feature. The method may include obtaining the trailing blur state information based on the position information and the trailing blur feature.

According to an embodiment of the disclosure, the method may include dividing the image feature into a first image feature corresponding to an edge area of the input image and a second image feature corresponding to a center area of the input image. The method may include dividing the first image feature corresponding to the edge area into patches of a first size and dividing the second image feature corresponding to the center area into patches of a second size, wherein the first size is smaller than the second size. The method may include obtaining a first feature and a second feature by performing a self-attention operation on the patches of the first size and the patches of the second size respectively. The method may include obtaining a third feature by performing a cross-attention operation on the first feature and the second feature. The method may include obtaining the trailing blur feature based on the third feature.

According to an embodiment of the disclosure, the method may include obtaining the position information of the object in the input image in a camera coordinate system based on camera parameters and a depth map corresponding to the input image.

According to an embodiment of the disclosure, the method may include obtaining a fourth feature by performing a self-attention operation on the position information and the trailing blur feature. The method may include obtaining the trailing blur state information based on the fourth feature.

According to an embodiment of the disclosure, the method may include obtaining polar coordinate encoding information corresponding to the input image. The method may include obtaining the trailing blur state information by performing up-sampling of the fourth feature based on the polar coordinate encoding information.

According to an embodiment of the disclosure, the method may include obtaining the output image by sequentially performing a feature encoding operation, a simulate aperture adjustment operation, and a feature decoding operation on the input image based on the trailing blur state information.

According to an embodiment of the disclosure, the method may include performing the feature encoding operation on the input image based on the trailing blur state information to obtain an encoded feature. The method may include performing the simulate aperture adjustment operation on the encoded feature based on the trailing blur state information and a preset aperture mapping pool to obtain an aperture-adjusted feature. The method may include performing the feature decoding operation on the aperture-adjusted feature based on the trailing blur state information to obtain the output image.

According to an embodiment of the disclosure, the trailing blur state information may include at least one of direction information, degree information, and probability information of trailing blur in at least one area.

According to an embodiment of the disclosure, at least one of the feature encoding operation, the simulate aperture adjustment operation, and the feature decoding operation may include a first convolution operation. According to an embodiment of the disclosure, the method may include adjusting a convolution kernel used in the first convolution operation based on the trailing blur state information.

According to an embodiment of the disclosure, the method may include at least one of: obtaining the encoded feature by performing a second convolution operation on the input image, and performing a first convolution operation on a feature obtained by the second convolution operation based on the trailing blur state information, or, obtaining the encoded feature by performing the first convolution operation on the input image.

According to an embodiment of the disclosure, the method may include obtaining a plurality of aperture features corresponding to a plurality of candidate aperture parameters based on aperture mapping parameters corresponding to the plurality of candidate aperture parameters in the preset aperture mapping pool. The method may include predicting aperture feature fusion weights based on the trailing blur state information. The method may include fusing the plurality of aperture features based on the predicted aperture feature fusion weights to obtain a first fusion feature. The method may include fusing the encoded feature with the first fusion feature to obtain a second fusion feature. The method may include obtaining the aperture-adjusted feature based on the second fusion feature.

According to an embodiment of the disclosure, the method may include at least one of: obtaining the aperture-adjusted feature by performing a first convolution operation on the second fusion feature based on the trailing blur state information, and performing a second convolution operation on a feature obtained by the first convolution operation, or obtaining the aperture-adjusted feature by performing the first convolution operation on the second fusion feature based on the trailing blur state information.

According to an embodiment of the disclosure, the method may include at least one of: performing a second convolution operation on the aperture-adjusted feature, and performing a first convolution operation on a feature obtained by the second convolution operation based on the trailing blur state information, and obtaining the output image based on a feature obtained by the first convolution operation, or, performing the first convolution operation on the aperture-adjusted feature based on the trailing blur state information, and obtaining the output image based on a feature obtained by the first convolution operation.

According to an embodiment of the disclosure, the trailing blur state information may include direction information, degree information, and probability information of trailing blur in at least one area. According to an embodiment of the disclosure, the method may include adjusting a value of a convolution kernel based on the degree information of the trailing blur, and adjusting a shape of the convolution kernel based on the direction information of the trailing blur. The method may include obtaining a first convolution feature by performing, by using the adjusted convolution kernel, a convolution operation on a feature on which the first convolution operation is to be performed. The method may include obtaining an output feature of the first convolution operation by fusing the feature on which the first convolution operation is to be performed and the first convolution feature based on the probability information of the trailing blur.

According to an embodiment of the disclosure, the method may include obtaining convolution fusion weight information based on the degree information of the trailing blur. The method may include obtaining the adjusted value of the convolution kernel based on the convolution fusion weight information and the convolution kernel to be adjusted.

According to an embodiment of the disclosure, the method may include estimating an initial convolution direction offset of the convolution kernel based on the feature on which the first convolution operation is to be performed. The method may include determining a final convolution direction offset based on the estimated initial convolution direction offset and the direction information of the trailing blur. The method may include adjusting the shape of the convolution kernel based on the final convolution direction offset.

According to an embodiment of the disclosure, the aperture mapping parameters corresponding to the plurality of candidate aperture parameters in the preset aperture mapping pool are obtained. According to an embodiment of the disclosure, the method may include obtaining an image captured at a predetermined aperture and each candidate aperture parameter. The method may include predicting, based on each candidate aperture parameter, the aperture mapping parameter corresponding to each candidate aperture parameter using a pre-trained prediction model. The method may include modulating an image feature of the image captured at the predetermined aperture based on the aperture mapping parameter corresponding to each candidate aperture parameter, and obtaining a target image corresponding to each candidate aperture parameter based on the modulated image feature.

According to an embodiment of the disclosure, an electronic apparatus may be provided. The electronic apparatus may include at least one processor including processing circuitry, memory storing instructions that, when executed by the at least one processor individually or collectively. The at least one processor may cause the electronic apparatus to obtain position information of an object in an input image. The at least one processor may cause the electronic apparatus to predict trailing blur state information of the input image, based on the position information and the input image. The at least one processor may cause the electronic apparatus to obtain an output image by performing processing on the input image, based on the predicted trailing blur state information.

According to the embodiment of the disclosure, the at least one processor may cause the electronic apparatus to perform the method disclosed in the disclosure.

According to an embodiment of the disclosure, a computer-readable storage medium storing instruction that, when executed by at least one processor, cause the at least one processor to obtain position information of an object in an input image. The computer-readable storage medium storing instruction that, when executed by at least one processor, cause the at least one processor to predict trailing blur state information of the input image, based on the position information and the input image. The computer-readable storage medium storing instruction that, when executed by at least one processor, cause the at least one processor to obtain an output image by performing processing on the input image, based on the predicted trailing blur state information.

According to the embodiment of the disclosure, the computer-readable storage medium storing instruction that, when executed by at least one processor, cause the at least one processor to perform the method disclosed in the disclosure.

What is claimed is:

1. A method performed by an electronic apparatus, comprising:
obtaining position information of an object in an input image;
predicting trailing blur state information of the input image, based on the position information and the input image; and
obtaining an output image by performing processing on the input image, based on the predicted trailing blur state information.

2. The method of claim 1, wherein the predicting of the trailing blur state information of the input image based on the position information and the input image, comprises:
obtaining an image feature of the input image by performing feature extraction on the input image;
obtaining a trailing blur feature of the input image based on the image feature; and
obtaining the trailing blur state information based on the position information and the trailing blur feature.

3. The method of claim 2, wherein the obtaining of the trailing blur feature of the input image based on the image feature, comprises:
dividing the image feature into a first image feature corresponding to an edge area of the input image and a second image feature corresponding to a center area of the input image;
dividing the first image feature corresponding to the edge area into patches of a first size and dividing the second image feature corresponding to the center area into patches of a second size, wherein the first size is smaller than the second size;
obtaining a first feature and a second feature by performing a self-attention operation on the patches of the first size and the patches of the second size respectively;
obtaining a third feature by performing a cross-attention operation on the first feature and the second feature; and
obtaining the trailing blur feature based on the third feature.

4. The method of claim 1, wherein the obtaining of the position information of the object in the input image, comprises: obtaining the position information of the object in the input image in a camera coordinate system based on camera parameters and a depth map corresponding to the input image.

5. The method of claim 3, wherein the obtaining of the trailing blur state information based on the position information and the trailing blur feature, comprises:
obtaining a fourth feature by performing a self-attention operation on the position information and the trailing blur feature; and
obtaining the trailing blur state information based on the fourth feature.

6. The method of claim 5, wherein the obtaining of the trailing blur state information based on the fourth feature, comprises:
obtaining polar coordinate encoding information corresponding to the input image; and
obtaining the trailing blur state information by performing up-sampling of the fourth feature based on the polar coordinate encoding information.

7. The method of claim 1, wherein the obtaining the output image by performing of processing on the input image based on the predicted trailing blur state information, comprises obtaining the output image by sequentially performing a feature encoding operation, a simulate aperture adjustment operation, and a feature decoding operation on the input image based on the trailing blur state information.

8. The method of claim 7, wherein the obtaining the output image by sequentially performing of the feature encoding operation, the simulate aperture adjustment operation, and the feature decoding operation on the input image based on the trailing blur state information, comprises:
performing the feature encoding operation on the input image based on the trailing blur state information to obtain an encoded feature;
performing the simulate aperture adjustment operation on the encoded feature based on the trailing blur state information and a preset aperture mapping pool to obtain an aperture-adjusted feature;
performing the feature decoding operation on the aperture-adjusted feature based on the trailing blur state information to obtain the output image.

9. The method of claim 1, wherein the trailing blur state information comprises at least one of direction information, degree information, and probability information of trailing blur in at least one area.

10. The method of claim 7, wherein at least one of the feature encoding operation, the simulate aperture adjustment operation, and the feature decoding operation, comprises a first convolution operation, and
wherein the obtaining the output image by sequentially performing of the feature encoding operation, the simulate aperture adjustment operation, and the feature decoding operation on the input image based on the trailing blur state information, comprises adjusting a convolution kernel used in the first convolution operation based on the trailing blur state information.

11. The method of claim 8, wherein the obtaining the encoded feature by performing of the feature encoding on the input image based on the trailing blur state information, comprises at least one of:
obtaining the encoded feature by performing a second convolution operation on the input image, and performing a first convolution operation on a feature obtained by the second convolution operation based on the trailing blur state information; or
obtaining the encoded feature by performing the first convolution operation on the input image.

12. The method of claim 8, wherein the obtaining the aperture-adjusted feature by performing of the simulate aperture adjustment operation on the encoded feature based on the trailing blur state information and the preset aperture mapping pool, comprises:
obtaining a plurality of aperture features corresponding to a plurality of candidate aperture parameters based on aperture mapping parameters corresponding to the plurality of candidate aperture parameters in the preset aperture mapping pool;
predicting aperture feature fusion weights based on the trailing blur state information;
fusing the plurality of aperture features based on the predicted aperture feature fusion weights to obtain a first fusion feature;
fusing the encoded feature with the first fusion feature to obtain a second fusion feature; and
obtaining the aperture-adjusted feature based on the second fusion feature.

13. The method of claim 12, wherein the obtaining of the aperture-adjusted feature based on the second fusion feature, comprises at least one of:
obtaining the aperture-adjusted feature by performing a first convolution operation on the second fusion feature based on the trailing blur state information, and performing a second convolution operation on a feature obtained by the first convolution operation; or
obtaining the aperture-adjusted feature by performing the first convolution operation on the second fusion feature based on the trailing blur state information.

14. The method of claim 8, wherein the obtaining the output image by performing of the feature decoding operation on the aperture-adjusted feature based on the trailing blur state information, comprises at least one of:
performing a second convolution operation on the aperture-adjusted feature, and performing a first convolution operation on a feature obtained by the second convolution operation based on the trailing blur state information, and obtaining the output image based on a feature obtained by the first convolution operation; or
performing the first convolution operation on the aperture-adjusted feature based on the trailing blur state information, and obtaining the output image based on a feature obtained by the first convolution operation.

15. The method of claim 10, wherein the trailing blur state information comprises direction information, degree information, and probability information of trailing blur in at least one area, and
wherein the first convolution operation comprises:
adjusting a value of a convolution kernel based on the degree information of the trailing blur, and adjusting a shape of the convolution kernel based on the direction information of the trailing blur;
obtaining a first convolution feature by performing, by using the adjusted convolution kernel, a convolution operation on a feature on which the first convolution operation is to be performed; and
obtaining an output feature of the first convolution operation by fusing the feature on which the first convolution operation is to be performed and the first convolution feature based on the probability information of the trailing blur.

16. The method of claim 15, wherein the adjusting the value of the convolution kernel based on the degree information of the trailing blur, comprises:
obtaining convolution fusion weight information based on the degree information of the trailing blur; and
obtaining the adjusted value of the convolution kernel based on the convolution fusion weight information and the convolution kernel to be adjusted.

17. The method of claim 15, wherein the adjusting of the shape of the convolution kernel based on the direction information of the trailing blur, comprises:
estimating an initial convolution direction offset of the convolution kernel based on the feature on which the first convolution operation is to be performed,
determining a final convolution direction offset based on the estimated initial convolution direction offset and the direction information of the trailing blur, and
adjusting the shape of the convolution kernel based on the final convolution direction offset.

18. The method of claim 12, wherein the aperture mapping parameters corresponding to the plurality of candidate aperture parameters in the preset aperture mapping pool are obtained by:
obtaining an image captured at a predetermined aperture and each candidate aperture parameter;
predicting, based on each candidate aperture parameter, the aperture mapping parameter corresponding to each candidate aperture parameter using a pre-trained prediction model;
modulating an image feature of the image captured at the predetermined aperture based on the aperture mapping parameter corresponding to each candidate aperture parameter, and obtaining a target image corresponding to each candidate aperture parameter based on the modulated image feature.

19. An electronic apparatus comprising:
at least one processor including processing circuitry,
memory storing instructions that, when executed by the at least one processor individually or collectively, cause the electronic apparatus to:
obtain position information of an object in an input image;
predict trailing blur state information of the input image, based on the position information and the input image; and
obtain an output image by performing processing on the input image, based on the predicted trailing blur state information.

20. A non-transitory computer-readable storage medium storing instructions that, when executed by at least one processor, cause the at least one processor to:
obtain position information of an object in an input image;
predict trailing blur state information of the input image, based on the position information and the input image; and
obtain an output image by performing processing on the input image, based on the predicted trailing blur state information.
